(19) United States
(12) Patent Application Publication
(10) Pub. No.: US 2015/0339771 A1
(43) Pub. Date: Nov. 26, 2015

(54) SYSTEM AND METHOD FOR OPTIMIZING ORDER EXECUTION

(71) Applicant: JPMorgan Chase Bank, N.A., New York, NY (US)

(72) Inventor: Benjamin F. SYLVESTER, Darien, CT (US)

(73) Assignee: JPMORGAN CHASE BANK, N.A., New York, NY (US)

(21) Appl. No.: 13/735,606

(22) Filed: Jan. 7, 2013

Related U.S. Application Data
(63) Continuation-in-part of application No. 12/837,624, filed on Jul. 16, 2010, now Pat. No. 8,352,354.
(60) Provisional application No. 61/307,216, filed on Feb. 23, 2010.

(51) Int. Cl. G06Q 40/04

(52) U.S. Cl. CPC G06Q 40/04

(57) ABSTRACT

An embodiment of the present invention is directed to a Trader Workstation that includes a user interface accessible by various users over a network communication link. The user interface of an embodiment of the present invention provides complex customized visualizations of fast moving real-time data and historical time series. The Trader Workstation increases trading efficiency and availability of data for traders by enabling traders to better monitor, analyze and plan trades. For example, using configurable views, filters and visualizations, traders may track and monitor orders in real time. An embodiment of the present invention may provide a trade analysis interface and a trade planning interface.

### CROSS REFERENCE TO RELATED APPLICATIONS

This patent application is a Continuation-in-Part of U.S. patent application Ser. No. 12/837,624, filed on Jul. 16, 2010, entitled “System and Method for Optimizing Order Execution,” now U.S. Pat. No. 8,352,354, which claims the benefit of U.S. Provisional Application No. 61/307,216, filed Feb. 23, 2010. The contents of these priority applications are hereby incorporated by reference in their entirety.

This application is related to co-pending U.S. application Ser. No. 12/708,975, entitled “Execution Optimizer,” the contents of which are hereby incorporated by reference in their entirety.

### FIELD OF THE INVENTION

Embodiments of the invention relate generally to automating execution of trades. More specifically, embodiments are directed to method and system for automatically processing an order and applying certain models and profiles to the order.

### BACKGROUND OF THE INVENTION

Investment banking covers a range of activities. Such activities include: underwriting, selling, and trading securities (e.g., stocks and bonds), providing financial advisory services such as mergers and acquisition advice, and managing assets. Investment banks offer these services to a variety of clients, both big and small, including, but not limited to, corporations, governments, non-profit institutions, and individuals. In addition, third party brokerage services provide many services similar to investment banks and interface with investment banks in many ways.

In the trading of securities, investment banking generally involves a buy side and a sell side. On the buy side, an investor or client provides the investment bank with an order. Typically the order is to conduct a transaction relating to securities, such as buying a certain amount of said securities. The order is typically placed with a person, such as a broker, trader, or portfolio manager. In many cases, the order is electronically placed over a computer network with the investment bank. The investment bank executes the order following receipt thereof. Depending upon various factors, such as size and price, the order is either be executed manually or executed automatically. Both types of execution typically occur in an appropriate computer based trading system. A delay in the execution of the order is possible. Such delays impact the order because market conditions are volatile. Changes in the market therefore occur from the time the order is placed to the time that the order is actually executed.

A delay in placing the order can have adverse consequences for the order. For example, the price of the security desired to be purchased can change, either up or down, between the time of order receipt and order execution. This is known as price slippage. Further, manually executing orders results in inconsistencies between orders.

### SUMMARY OF THE INVENTION

An embodiment of the present invention provides a computer-implemented method for optimizing execution of an order. The method may involve the processing of trading orders. Orders may be placed into a trading system by a portfolio manager. The order may then be electronically routed to an Execution Optimizer (“EO”). The EO may be a computer based system with a number of components, applications, or modules, including a rules engine. Resident within the EO may be a series of profiles corresponding to a group of portfolio managers who are associated with the trading system. The EO may apply a particular profile, corresponding to a particular portfolio manager. Each profile may be based upon a particular portfolio manager's trading habits and historical trading profile. Hence, the profile may be designed to capture the trading habits of that portfolio manager. Each profile may be updated periodically. A profile may be based on historical data of the particular portfolio manager's portfolio. The application of the profile may be the appending, electronically, of the profile to the order.

Next, the order, with the profile, may be routed, electronically, to a third party. In some orders, the order may be flagged for manual execution, in which case a trader will handle the order processing, without the order being routed to the third party. At the third party, a prediction model may be applied to the order, indicating trading parameters for the order. The prediction model may be a price prediction model. The prediction model may use the profile information as parameters for the prediction model.

The order, with the trading parameters from the prediction model, may be passed back to the EO. In the EO, a rules engine will apply rules, specific to the executing financial institution, to the order. The order may then be passed to a selected broker for market trading. The selected broker may be determined by the rules. The EO has the capability to receive real time feedback on the order as it is traded. This feedback may be sent to the third party. The feedback may be used to update the prediction model and rules such that processing of the order may be adjusted in real time based on this market feedback. The rules engine can therefore apply iterative processing of the order.

An embodiment provides a computer-implemented method for optimizing automatic execution of an order for securities. An order for specified securities may be received. A profile may be applied to the order. The profile may be associated with a portfolio manager. The order and the profile may be routed to a third party for application of a prediction model to the order. The results from the prediction model may be received and a set of rules may be applied to the order. The order may be routed for execution in accordance with the set of rules and the results from the prediction model. Feedback may be received on the execution of the order. The set of rules may be updated based on the feedback and the feedback may be forwarded to the third party to update the prediction model.

Another embodiment provides a computer based system for optimizing automatic execution of an order for securities. The system may have a network with one or more servers, a workstation communicatively coupled to the network and providing an interface to the computer based system, an execution optimizer module, communicatively coupled to the network, and a database, communicatively coupled to the execution optimizer module. The execution optimizer module may perform the following functions: receiving an order for specified securities, determining a profile associated with a portfolio manager to apply to the order, applying the profile to the order, routing the order and the profile to a prediction engine, receiving results associated with the order from the prediction engine, applying a set of rules, using a rules engine module, to the order for determining the execution strategy for the order, forwarding the order for execution based on the prediction engine results and the set of rules, receiving feedback on the execution of the order, applying the feedback in real time to update the set of rules; and forwarding the feedback to the prediction engine. The database may contain the set of rules and the profile.

Another embodiment of the present invention is directed to a Trader Workstation that includes a user interface accessible by various users over a network communication link. The user interface of an embodiment of the present invention provides complex customized visualizations of fast moving real-time data and historical time series. The Trader Workstation increases trading efficiency and availability of data for traders by enabling traders to better monitor, analyze and plan trades. For example, using configurable views, filters and visualizations, traders may track and monitor orders in real time. An embodiment of the present invention may provide a trade analysis interface and a trade planning interface.

Advantages of this invention in addition to those described above are apparent from the following detailed description of exemplary embodiments of the invention.

### BRIEF DESCRIPTION OF THE DRAWINGS

FIG. 1 is a flow chart of a method of executing of an order in accordance with exemplary embodiments.

FIG. 2 is a system for executing of an order in accordance with exemplary embodiments.

FIG. 3 is a flow chart of a system for executing of an order in accordance with exemplary embodiments.

FIGS. 4A, 4B, 4C, and 4D are data fields associated with execution of an order in accordance with exemplary embodiments.

FIG. 5 shows a graphical user interface in accordance with exemplary embodiments.

FIG. 6 shows a graphical user interface in accordance with exemplary embodiments.

FIG. 7 shows a graphical user interface in accordance with exemplary embodiments.

FIG. 8 shows a graphical user interface in accordance with exemplary embodiments.

FIG. 9 shows a graphical user interface in accordance with exemplary embodiments.

FIG. 10 is an exemplary screen shot of a home screen in accordance with exemplary embodiments.

FIG. 11 is a detailed view of block orders in accordance with exemplary embodiments.

FIG. 12 illustrates exemplary block order interactions in accordance with exemplary embodiments.

FIG. 13 illustrates exemplary block order interactions in accordance with exemplary embodiments.

FIG. 14 illustrates an exemplary pending orders feature in accordance with exemplary embodiments.

FIG. 15 illustrates exemplary basket interactions in accordance with exemplary embodiments.

FIG. 16 illustrates an exemplary watch list in accordance with exemplary embodiments.

FIG. 17 illustrates a detail view of an exemplary watch list in accordance with exemplary embodiments.

FIGS. 18A and 18B are exemplary order active trade details screenshots in accordance with exemplary embodiments.

FIG. 19 is an exemplary illustration of a planning screen for order details in accordance with exemplary embodiments.

FIG. 20 is an exemplary screen shot illustrating analysis for a new order in accordance with exemplary embodiments.

FIG. 21 is an exemplary screen shot illustrating a planning page or a new order page in accordance with exemplary embodiments.

FIG. 22 is an exemplary flowchart of a method for optimizing the execution of an order in accordance with exemplary embodiments.

These and other embodiments and advantages will become apparent from the following detailed description, taken in conjunction with the accompanying drawings, illustrating by way of example the principles of the various exemplary embodiments.

### DETAILED DESCRIPTION OF THE PREFERRED EMBODIMENTS

It will be readily understood by those persons skilled in the art that the embodiments of the inventions described herein are capable of broad utility and application. Many embodiments and adaptations of the embodiments of the inventions other than those herein described, as well as many variations, modifications and equivalent arrangements, will be apparent from or reasonably suggested by the embodiments of the inventions and foregoing description thereof, without departing from the substance or scope of the invention.

Accordingly, while the embodiments of the invention have been described herein, in detail in relation to the exemplary embodiments, it is to be understood that this disclosure is illustrative and exemplary of embodiments of the invention and is made to provide an enabling disclosure of the invention. Accordingly, the subsequent disclosure is not intended to be construed to limit the embodiments of the invention or otherwise to exclude any other such embodiments, adaptations, variations, modifications and equivalent arrangements. While the various embodiments of the present invention are described in the context of execution optimization for orders in the context of security trading, the methods and systems described herein may be applied to other related items, such as other types of financial transactions.

Exemplary embodiments of the present invention provide systems and methods for optimizing the automatic execution of orders for securities, including application of profiles, models, and rules for the execution optimization of these orders. Exemplary embodiments provide a method and system that is designed to: (a) be adaptable, (b) be scalable, (c) be fault tolerable, (d) have speed of delivery, and (e) be configurable.

Application of embodiments of the present invention may be primarily in investment banking. However, one of ordinary skill in the art may appreciate application to other fields that use similar algorithms to automate execution of tasks. The use of the term “investment bank” or “financial institution” in the present application is used for illustrative examples, and is not meant to be limiting on the scope of the exemplary embodiments. Furthermore, the use of the term “securities” or “stocks” or “bonds” in the exemplary embodiments is used merely for illustrative examples is not meant in any way to be limiting upon the exemplary embodiments.

Exemplary embodiments involve the processing of orders, such as, but not limited to, orders for domestic securities. However, the embodiments described herein may be applied to any type of trading order. For example, embodiments may be applied to international trading orders or a combination of domestic and international trading orders.

An order may be placed for one or more securities. The order may be placed with an investment bank or similar entity. By way of non-limiting example, an order for 10,000 shares of stock may be placed with an investment bank. The shares may be all from the same entity or may be a combination of different entities. For example, the order may be for stock of a plurality of corporations, for example all blue chip corporations. The order may originate with a portfolio manager. The portfolio manager may input the orders into a trading system. The order may be input at a workstation coupled to a computer based network. The order may be processed by the trading system. The processing may include validation of the order. As part of the input, the portfolio manager may input certain parameters regarding the order. For example, the portfolio manager may set a flag for manual execution of the order indicating that the order is not to be automatically executed according to exemplary embodiments.

Following the trading system processing, the order may then be routed to an Execution Optimizer (“EO”). The EO may be part of a separate computer system coupled to the trading system, coupled by a computer based network to the trading system. Alternatively, the EO may be a module, such as a software module, resident in the trading system. The EO may be communicatively coupled to one or more databases that contain data according to exemplary embodiments.

Resident within the EO may be a series of profiles corresponding to a group of portfolio managers who are associated with and/or use the trading system. Each portfolio manager may have a profile. Each profile may be based upon a particular portfolio manager's trading habits and historical trading profile. Hence, the profile may be designed to capture the trading habits of that portfolio manager; that is, the profile is designed to replicate the behavior of the portfolio manager and the portfolio. Each profile may be updated periodically. A profile may be based on historical data of the particular portfolio manager's portfolio. For example, price slippage may be used as a metric within the portfolio manger's profile. The EO may apply a particular profile, corresponding to the portfolio manager. The application of the profile may be the appending, electronically, of the profile to the order. By way of another non-limiting example, a particular portfolio manager may be very aggressive with morning orders and may look to have such trades completed quickly, while tolerating pricing movement or market impact. This portfolio manager may then be more passive with afternoon trades. The profiles are designed to capture this behavior and provide the EO with the information to dictate how the orders are to be traded. According to exemplary embodiments, the portfolio manager does not typically trade the securities himself or herself but enters the orders based upon their investment strategies.

The order, with the profile, may be routed to a third party. In some orders, the order may be flagged for manual execution, in which case a trader will handle the order processing, without the order being routed to the third party. The routing may be the communication of the order over a computer network to the third party. At the third party, a prediction or performance model may be applied to the order, indicating trading parameters for the order. The prediction model may be a price prediction model. The prediction model may use the profile information as parameters for the prediction model. For example, the model may predict the upper and lower bounds on price for a sub-set of the total order and the timeframe to execute the order, as well as indicate how to trade the order. As another example, the model may be a performance model that predicts how the given security is going to perform in the present market. Referring back to the aforementioned order for 10,000 shares, the model may predict that 5,000 shares should be traded aggressively between a set of price bounds in the next 15 minutes. The remaining shares of the order may have a similar prediction. For example, the remaining 5,000 shares may be predicted to be traded in 1,000 share increments, not as aggressively, following the trading of the initial 5,000 shares.

Some orders may be routed to multiple third parties and have other models applied. These other models may be based on other parameters. For example, historical trading data, such as price slippage, for the stock in the order may be predicted. According to alternative embodiments, the order may have a model applied by the EO or another system associated with the investment bank. That is, the order may be internally processed without interaction with a third party. The order may have a flag set by the portfolio manager indicating how the order is processed.

The order, with the trading parameters from the prediction model, may be passed back to the EO. A rules engine associated with the EO may apply rules. These rules may be specific to the executing investment bank. For example, the rules may further break up the order into smaller size chunks based on the investment bank's broker's rules. The rules may select a broker based on various factors. By way of non-limiting example, the broker may be selected based upon the type of order, commission, trading history, and volume of the order. For example, the rules may select a broker based on the order being for a large cap fund. The order may then be passed to a selected broker for market trading. The selected broker may be determined by the rules. The order may be passed to the broker via direct paths for market trading. For example, the order may be forwarded to the broker by way of a direct market access pipe.

The EO has the capability to receive real time feedback on the order as it is traded. This feedback may be sent to the third party. The feedback may be used to update the prediction model and rules such that processing of the order may be adjusted in real time based on this market feedback. The rules engine can therefore apply iterative processing of the order. For example, based on feedback from the trading of the first block of share of the order, the trading parameters may be adjusted in real time. Brokers may be contacted to pull back orders or to cancel orders based on the revised information.

Manual intervention during the processing of the order may occur at any time up to the actual execution of the order. Further, the rules, models, and profiles applied to the order can be edited during the processing of the order.

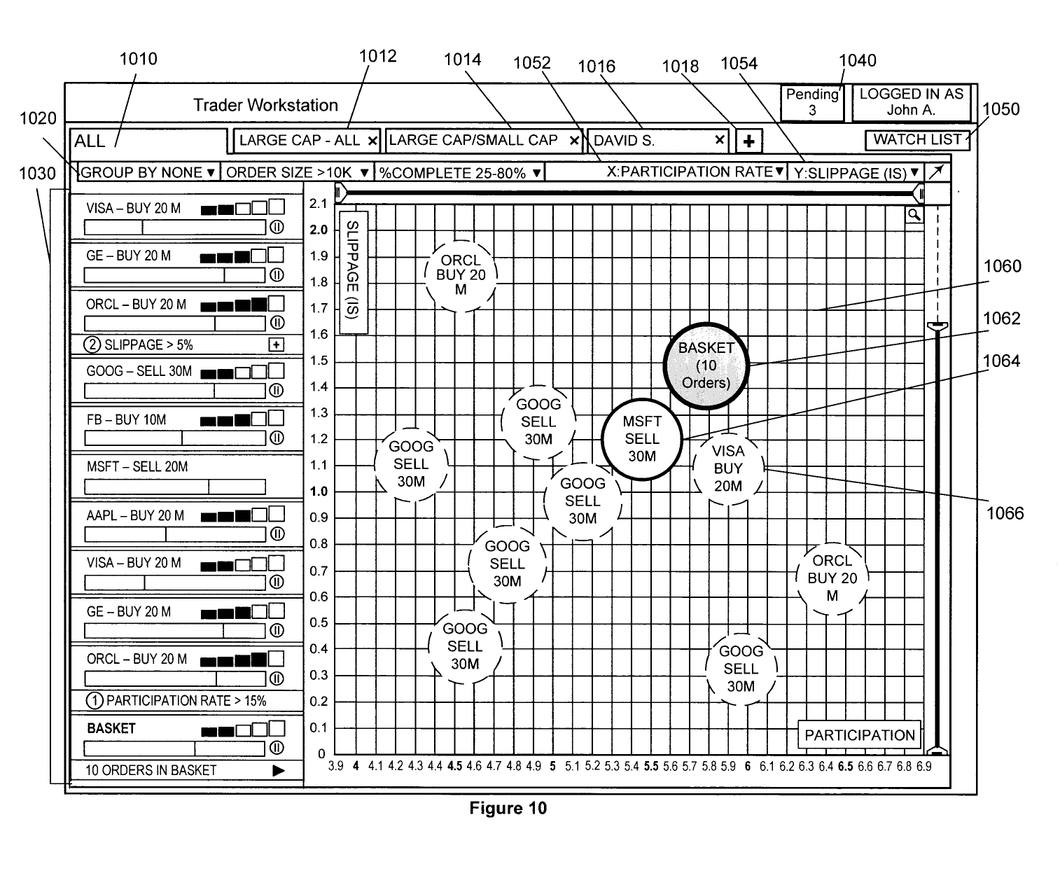

In order to provide support for the system and methods described herein, such as the EO, a trader workstation has been developed. FIGS. 10 through 22, described below, provide details on the trader workstation and its visualization layer. This workstation is a desktop application that allows traders to monitor, analyze, and plan orders. Importantly, the workstation provides an interface with the EO and additional visualization capabilities. While the EO has an interface as described herein, the trader workstation provides an additional upgraded interface capability. Using the configurable views, filters, and visualizations, traders can track and monitor orders in real time. Capabilities of the trader workstation include: a trade analysis screen and a trade planning screen.

The trade analysis screen gives traders in-depth insights into active trade performance and projects the outcome for an order. The trade analysis screen may include:
Real-time insight into trade performance including slippage, participation rate, and profit and loss (P+L);
Custom alert configuration for order thresholds;
Detailed analysis of market performance including liquidity and pricing profiles;
Order projection (slippage and participation rate) for selected strategy;
Mid-order what-if prediction and analysis on alternative order strategies; and
Access to historical order movement and activity.

The trade planning screen provides traders with insights when planning order execution to ensure their strategy is optimized to maximize opportunity. The trade planning screen may include:
Historical trade profile analytics for portfolio managers, sectors, and similar sized trades;
Detailed analysis of market performance including liquidity and pricing profiles;
Generation and visualization of trade schedules (including expected participation rate and P+L); and
Custom alert configuration for order thresholds.

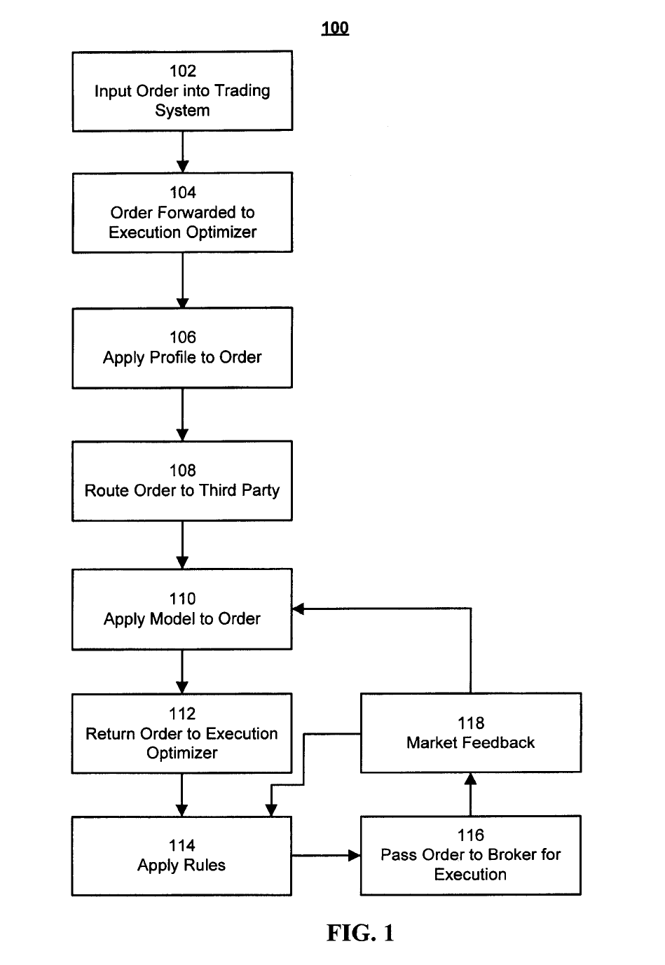

FIG. 1 depicts a flow chart of a method of optimizing the execution of an order according to exemplary embodiments. Exemplary method 100 is provided by way of example, as there are a variety of ways to carry out the methods disclosed herein. The method 100 as shown in FIG. 1 may be executed or otherwise performed by one or a combination of various systems, such as a computer implemented system. Each block shown in FIG. 1 represents one or more processes, methods, and/or subroutines carried out in the exemplary method 100. Each block may have an associated processing machine or the blocks depicted may be carried out through one processor machine. While the exemplary method 100 may use an order from a client for stocks as an example of optimizing an order, the method shown in FIG. 1 may be applied to other types of orders, such as other securities or other types of financial transactions.

While the method of FIG. 1 illustrates certain steps performed in a particular order, it should be understood that the embodiments of the present invention may be practiced by adding one or more steps to the processes, omitting steps within the processes and/or altering the order in which one or more steps are performed.

The method of FIG. 1 may commence with receipt of an order at block 102. An order is input into a trading system. For example, a portfolio manager may input an order into the trading system. The trading system may be one as known in the art. For example, the Longview Trading System (“LVTS”) may be used. Other trading systems or combinations thereof may be used. It should be appreciated that other persons may input the order, such as a broker or a person working for or associated with the portfolio manager. The placing and execution of all order flow may be handled by a particular application, module, or system. For example, the EO may handle the placing and execution of all order flow. In alternative embodiments, the FIX engine application may be used. Other applications, modules, or systems, or combinations thereof may be used.

The order may be of any type. For example, the order may be for a purchase or transaction relating to one or more securities. For example, the securities may be domestic stocks or bonds. According to exemplary embodiments, the investment bank may originate the order. For example, the investment bank, such as JPMorgan Chase Bank, N.A., may have funds invested therewith by one or more clients. The clients may authorize the investment bank, through the portfolio manager to invest those funds in accordance with an investment strategy. The orders entered into the trading system may be placed by personnel internal to the investment bank. For example, the portfolio manager or personnel associated therewith. Orders may also be received from a third party, for example a private bank associated with the investment bank, through an automated generation process that may follow a designated investment strategy associated with the investment bank. Alternatively, the order may be placed by an investment team according to an investment strategy. The order may be entered into the trading system. For example, a person, such as the portfolio manager or an investment assistant, may enter the order into the trading system. According to exemplary embodiments, a third party may enter the order. For example, the order may be relayed to the third party for entry into the trading system. In certain cases, the order may be automatically entered into the trading system. For example, through an internet site. The order may be directly fed into the trading system from the internet site without external intervention. It should be appreciated that combinations of both automatic and manual entry for the order are possible.

Upon entry into the trading system, the order may have certain options selected that may influence the order execution. Further, upon entry of the order into the system, the person or system entering the order may configure certain settings and/or flags relating to the order. In the case of a system entering the order, the certain settings and/or flags may be automatically configured by the system entering the order. Such settings and/or flags may determine how the order is processed within the trading system. For example, a flag may be set on the order which disables autorouting for the order. In such cases, the order may immediately go into an appropriate queue for manual processing. Generally, the order may be autorouted and not indicated for manual processing by default. Additionally, an order may have special instructions and/or constraints associated therewith. The special instructions and/or constraints may be entered with the order. Alternatively, the special instructions and/or constraints may be standing rules previously agreed upon and programmed into the trading system prior to the entry of the order. The special instructions and/or constraints may be applied to all orders associated with or originating from a particular client or customer. For example, a special instruction for all orders from client A may be to disable autorouting. According to exemplary embodiments, only certain types of orders may have the methods described herein applied thereto. For example, the certain types of orders may include: large cap, mid/small cap active and private bank (single orders) orders, structured equity orders, contingent orders, United States domestic equity securities orders, and international orders. Other types of orders, upon entry, may be automatically routed to a manual queue, bypassing the automatic execution system.

Following entry of the order into the trading system at block 102, a series of processing checks may be performed on the order to ensure that the order is properly entered and ready for execution by the system and method according to exemplary embodiments.

At block 104, the order is forwarded to the execution optimizer or EO. The order may be forwarded by the trading system. The order may be forwarded automatically after entry into the trading system. The order may require a physical action to be forwarded. For example, the portfolio manager may select an option to forward the order. According to exemplary embodiments, the order may be flagged as either an error or a warning. Both cases may be flagged for further review. An error order may be not continue through the method described herein. For example, the error order may not be forwarded to a third party for application of the prediction model as described herein. A warning order may be allowed to continue.

At block 106, a profile is applied to the order. The application of the profile may consist of the profile being appended to or associated with the data of the order. For example, the profile may be electronically appended to the data file containing the order. Resident within the EO may be a series of profiles corresponding to a group of portfolio managers who use the trading system. Each portfolio manager may have a profile. Each profile may be based upon a particular portfolio manager's trading habits and historical trading profile. Hence, the profile may be designed to capture the trading habits of that portfolio manager; that is, the profile is designed to replicate the behavior of the portfolio manager if he was personally executing the order. Each profile may be updated periodically. For example, portfolio manager information may be pulled from the order system at set intervals throughout the day. This data may be used to update the profiles at set intervals. A profile may be based on historical data of the particular portfolio manager's portfolio. For example, price slippage may be used as a metric within the portfolio manger's profile. The EO may apply a particular profile, corresponding to the portfolio manager. The application of the profile may be the appending, electronically, of the profile to the order. The EO may use an events processing system. For example, the EO may use Streambase as the events processing system.

At block 108, the order is routed to a third party. The order may be routed electronically to the third party. For example, the third party may be a vendor that supplies services, such as model predictions or algorithm application to orders. The model applied may be proprietary to the third party. For example, Automated Trading Desk (“ATD”) may be the third party and provide one or more price prediction models to apply to orders routed to them. Other third parties may be used. A combination of prediction models may be applied to the order. In some embodiments, this block may be omitted. That is, the method 100 may proceed to block 110 and skip block 108 entirely.

At block 110, a model is applied to the order. The model may be of any kind. For example, the model may be a price prediction model that may output a price range, including an upper and lower price bound, a trading style, such as aggressive, a time frame to trade the order, and an particular size for the order that is a sub-set of the total order size. For example, for an order for 3,000 shares of company X, the model may output that this order should be traded in 500 share blocks, between $6.50 and $7.38, aggressively, in the next 10 minutes. The model may be a performance model for the security. It should be appreciated that other model types and predictions are possible. For example, a model which uses basis points or bid offer spread may be used. It should be appreciated that such models may be proprietary in nature.

The model may apply the profile in determining the prediction. For example, the data contained in the profile may be used as parameters for the model.

At block 112, the order is returned to the execution optimizer. The order may be returned with the model prediction included.

At block 114, a set of rules is applied to the order. A rules engine associated with the EO may apply rules. These rules may be specific to the executing investment bank. For example, the rules may further break up the order into smaller size chunks based on the investment bank's broker's rules. The rules may select a broker based on various factors. By way of non-limiting example, the broker may be selected based upon the type of order, commission, trading history, and volume of the order. For example, the rules may select a broker based on the order being for a large cap fund.

The EO may determine the strategy and the broker. This data may be passed to the trading system and then out to the executing destination. The data may be passed directly from the EO to the third party. The trading system may create the placements and receive the fills from the brokers. The trading system may publish this data back to the prediction engine through the EO.

At block 116, the order is passed to a broker for execution. The order may be passed with appropriate instructions for execution based on the applied rules above. The broker may then trade the order on the market. The order may be passed to the broker via direct paths for market trading. For example, the order may be forwarded to the broker by way of a direct market access (“DMA”) pipe execution management system (“EMS”). It should be appreciated that many direct access pipes are provided by third party vendors. For example, the Lava Execution Management System is a direct market access product provided by a third party. The order may be routed from the EO to the trading system and them to the brokers through the designated pipes.

At block 118, feedback is received from the market. The feedback may be received in real time. For example, the EO has the capability to receive real time feedback on the order as it is traded. This feedback may be sent to the third party at block 108. The feedback may be used to update the prediction model and rules such that processing of the order may be adjusted in real time based on this market feedback. The rules engine can therefore apply iterative processing of the order. For example, based on feedback from the trading of the first block of share of the order, the trading parameters may be adjusted in real time. Brokers may be contacted to pull back orders or to cancel orders based on the revised information. The brokers may provide feedback on order fills. The feedback may be received by the trading system and passed to the EO.

Further, according to exemplary embodiments, the order may be cancelled, amended, or removed from automatic execution at any point in the process, up to the actual execution of the order. A user may enter an appropriate command into the EO or trading system to perform such actions. If the user enters a command to cancel, amend, or remove the order from automatic execution, and such order fails, the user may be provided with an appropriate message indicating the reason for the failure.

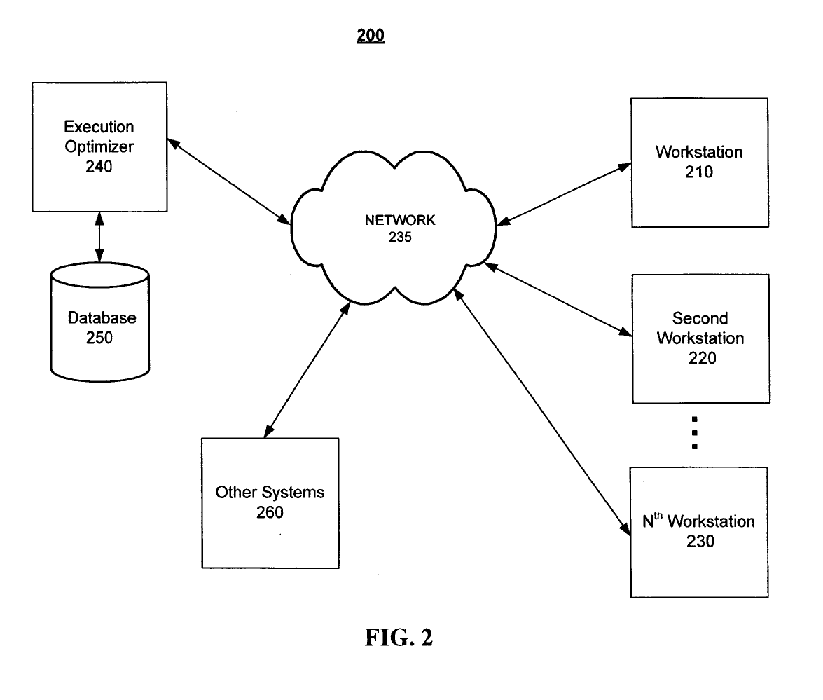

FIG. 2 is a system for optimizing the execution of an order, according to an exemplary embodiment of the present invention. The system 200 may provide various functionality and features associated with execution optimization. More specifically, the system 200 may include a workstation 210, a second workstation 220, and an Nth workstation 230, a network 235, execution optimizer 240, a database 250, and other systems 260. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that the system 200 may be integrated into and run on a computer, such as a general purpose computer which may include a processing machine which has one or more processors. Such a processing machine may execute instructions stored in a memory to process the data. The system 200 may be integrated into and run on one or more computer networks which may each have one of more computers associated therewith.

As noted above, the processing machine executes the instructions that are stored in the memory or memories to process data. This processing of data may be in response to commands by a user or users of the processing machine, in response to previous processing, in response to a request by another processing machine and/or any other input, for example. As described herein, a module performing functionality may comprise a processor and vice-versa.

According to exemplary embodiments, the system 200 may be configured to carry out the method 100 as described above. The system 200 may have a workstation 210 associated therewith. A second workstation 220 and an Nth workstation 230 may be further associated with the system 200. The workstations 210, 220, and 230 may each be a processing machine, such as a general purpose computer. Each workstation 210, 220, and 230 may include software and/or modules to implement the method 100 according to exemplary embodiments. Each workstation 210, 220, and 230 may provide processing, display, storage, communications, and execution of commands in response to inputs from a user thereof and respond to requests from the software and/or modules. The workstations 210, 220, and 230 may each serve as a client side. Each workstation 210, 220, and 230 may be a fat client, such that the majority of the processing may be performed on the client. Alternatively, the workstations 210, 220, and 230 may each be a thin client, such that the majority of the processing may be performed in the other components of the system 200. The workstations 210, 220, and 230 may be a part of the trading system according to exemplary embodiments. Further, the workstations 210, 220, and 230 may be configured to perform other functions and processing beyond the method 100. The workstations 210, 220, and 230 may each be a part of a larger system associated with the investment bank. That is, the workstations 210, 220, and 230 may be multi-functional in operation.

The workstations 210, 220, and 230 may be communicatively coupled to a network 235. Network 235 may be a computer based network, comprising one or more servers and/or computer processors. For example, network 235 may be the internet. Information and data may be exchanged through the network 235 between the various components of the system 200. In alternative embodiments, the network 235 may be a local area network within the investment bank. It should be appreciated that the network 235 may be a combination of local area networks, wide area networks, and external networks.

The execution optimizer 240 may be communicatively coupled to the network 235. The execution optimizer 240 may perform operations associated with the establishment, editing, and application of the profiles and rules according to exemplary embodiments. The execution optimizer may receive the order from the trading system, apply the profile, receive the order from the third party, apply rules to the order, and pass the order for execution. The execution optimizer 240 may receive feedback, in real time, from the market, and disseminate and apply the data received as required. The execution optimizer 240 may perform other functions. In some embodiments, the execution optimizer 240 may be a part of the same system as the workstations 210, 220, and 230. The execution optimizer 240 may consist of one or more servers and/or general purpose computers, each having one or more computer processors associated therewith.

The execution optimizer 240 may have a database 250 communicatively coupled thereto. The database 250 may contain the rules, profiles, and other data used by the system 200. Additional information may be contained therein related to the operation and administration of the system 200. The database 250 may include any suitable data structure to maintain the information and allow access and retrieval of the information. For example, the database may keep the data in an organized fashion. The database 250 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein. The database 250 may be more than one database. The database 250 may be associated with multiple components of the system 200.

The database 250 may be stored in any suitable storage device. The storage device may include multiple data storage devices. The multiple data storage devices may be operatively associated with the database 250. The storage may be local, remote, or a combination thereof with respect to the database. The database 250 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fibre Channel SAN, a common Internet File System (CIFS), network attached storage (NAS), or a network file system (NFS). The database may have back-up capability built-in. Communications with the database 250 may be over a network, such as the network 235, or communications may be over a direct connection between the database 250 and the execution optimizer 240, as depicted in FIG. 2. Data may be transmitted and/or received from the database 250. Data transmission and receipt may utilize cabled network or telecom connections such as an Ethernet RJ45/Category 5 Ethernet connection, a fiber connection, a traditional phone wireline connection, a cable connection or other wired network connection. A wireless network may be used for the transmission and receipt of data.

The system 200 may have other systems 260 associated therewith. These other systems 260 may include various data collection and support systems used by the investment bank to carry out its functions.

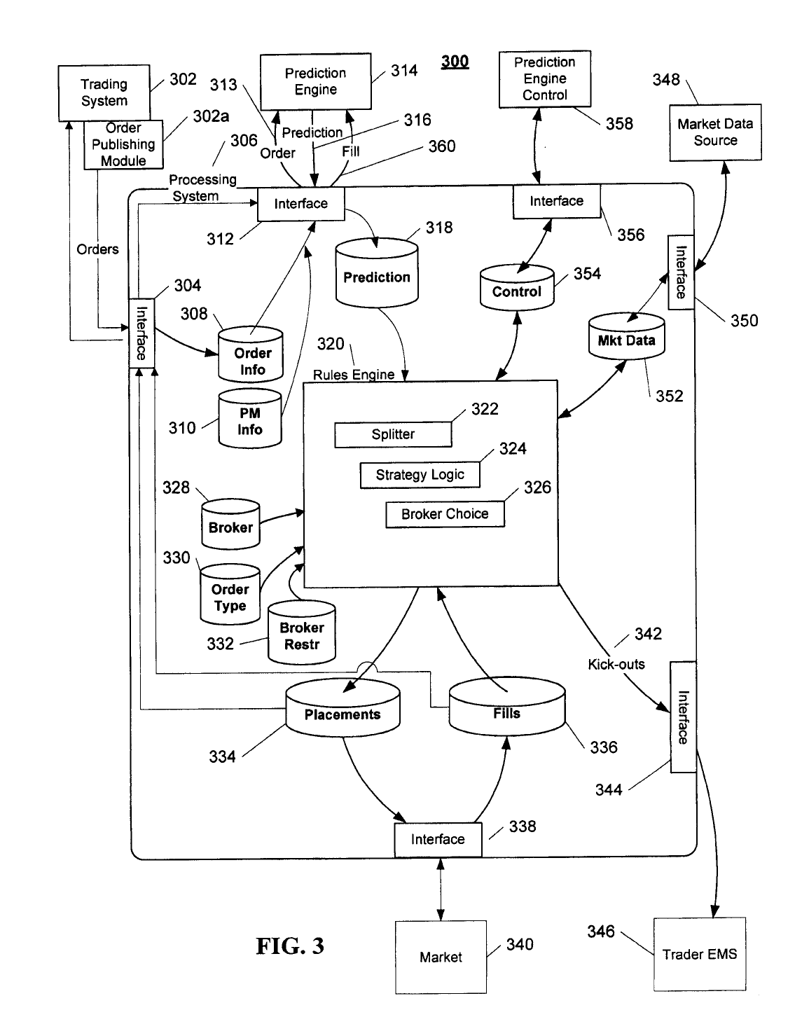

FIG. 3 provides a flow chart for a system according to exemplary embodiments. The system 300 may provide various functionality and features associated with execution optimization. More specifically, the system 300 may be configured to implement the methods for execution optimization described herein, such as the method 100 described above. The system 300 may contain the various components depicted in the system 200. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. While the system 300 is depicted with data flowing in a particular manner between the various components, it should be appreciated that a variety of data flow paths may be realized and the arrows in the system 300 showing the flow of data are exemplary only. For example, some arrows may indicate a one way direction of flow and these arrows may be configured for a two way direction of flow. Further, data may be routed between in the various components in a variety of paths and manners.

It should be appreciated that the system 300 may be integrated into and run on a computer, such as a general purpose computer which may include a processing machine which has one or more processors. Such a processing machine may execute instructions stored in a memory to process the data. The system 300 may be integrated into and run on one or more computer networks which may each have one of more computers associated therewith. The system 300 may have a number of databases associated with it. It should further be appreciated that the system 300 may be associated with multiple computers or servers and multiple computer networks.

A trading system 302 may be used to input an order or may receive an order. For example, a portfolio manager may input an order into the trading system or an order may be electronically communicated to the trading system from an external source, such as a computer network. The trading system may be one as known in the art. For example, the Longview Trading System (“LVTS”) may be used. Other trading systems or combinations thereof may be used. It should be appreciated that other persons may input the order, such as a broker or a person working for or associated with the portfolio manager. Other applications, modules, or systems, or combinations thereof may be used. The order may be communicated to an interface 304. The interface 304 may be associated with a processing system 306. As described herein, the order may be of any type. For example, the order may be for a purchase or transaction relating to one or more securities.

The trading system 302 may have an order publishing module 302a associated therewith. The order publishing module 302a may have two mechanisms to publish orders. For example, the two mechanisms may be an initialize process to start-up in the morning or re-synch during the day and a mechanism to publish just changes to the orders throughout the day. According to exemplary embodiments, the order in the order publishing module may be flagged as either an error or a warning. Both cases may be flagged for further review. An error order may be not continue through the method described herein. For example, the error order may not be forwarded to a third party for application of the prediction model as described herein. A warning order may be allowed to continue.

The trading system 302 may have symbol information associated with it for use with the orders. The symbol information may contain basic symbol information that is required for an order to determine the correct order categorization by the prediction engine. For example, the symbol data may include the stock's previous closing price, the average daily volume, the median inside size, and the primary market center. According to exemplary embodiments, an initial load each day may contain the symbol data for all symbols traded in the last six months. For each order received, a check is performed to see if the symbol from the order is in the symbol data. If it is not, it may be added to the data. A function of the symbol data may be to ensure that appropriate market data is subscribed to in order to update the various databases and rules used for the handling of orders as described herein. The order publishing module 302a may perform a check on the symbol data during the processing of the order. It should be appreciated that the symbol information may be associated with the processing system 306 as described herein.

Following transmission of the order to the interface 304, a series of processing checks may be performed on the order by the processing system 306 to ensure that the order is properly entered and ready for execution by the system and method according to exemplary embodiments. The order and its associated information is sent to an order information module 308. The order information may be stored within the order information module 308 for future use by the processing system 306. Once the validation is performed on the order, the order may have a portfolio manager (“PM”) profile associated therewith. The PM information module 310 may perform this function. The PM information module 310 may store and process the PM profile as described herein.

The PM information module 310 may contain portfolio manager fit data. The portfolio manager fit data may contain all of the prediction coefficients for each portfolio manager and order sub-type. This data may be accessed by or associated with the prediction engine 314 in order to generate new predictions upon order entry. A database may hold historical prediction information, in order to facilitate the traders looking back at previous performance. The database may hold data for a given period of time historically, along with current day prediction information on orders that have been completed or canceled.

The portfolio manager fit selector may listen to each order block that enters the system 300 and may selects the appropriate fit from the table of portfolio manager fits that may be loaded each day. The portfolio manager fit selector may be associated with the prediction engine 314. The portfolio manager fit selector may publish this information to a stream, where it may be used as the base for a backup strategy, in case the primary strategy ever becomes unavailable. The portfolio manager fit selector may:

Load into a table the set of PM fits for that day

Listen to new orders and select the fit for that order, based on appropriate factors.

Publish this fit selection to a table, mapped to the order.

Listen for orders for a given block and update the current fit table as required.

The order with the PM profile may be forwarded to an interface 312. The order and the PM profile information may be entered into a prediction engine 314, as shown by the arrow 313. The information may be forwarded to a third party, which manages the prediction engine. For example, the prediction engine may be associated with and/or proprietary to a third party. In some embodiments, the prediction engine may be part of the processing system 306 and may be associated with, managed by, and/or proprietary to the investment bank or other institution that has the processing system 306. The prediction engine 314 may apply a proprietary model to the order. For example, Automated Trading Desk (“ATD”) may be the third party and provide one or more price prediction models to apply to orders routed to them. Other third parties may be used. A combination of prediction models may be applied to the order. In alternative embodiments, the prediction engine may be associated with the processing system; that is, the prediction engine may not be associated with a third party. In some embodiments, this block may be omitted. That is, the order may be routed to a rules engine for further processing as described below.

The prediction engine 314 may apply the model to the order. The PM profile information may be used by the prediction engine as configuration data for the model to tailor the output based upon the PM profile. Upon completion of the model application, the order is returned to the execution optimizer as shown by the arrow 316. The order may be returned with the model prediction included. In some embodiments, the order data may not be sent back since the processing system 306 may store the order data and only the prediction information need be returned. The prediction information may be communicated to the interface 312. The prediction data may be forwarded to the prediction module 318 for additional processing. Upon completion of this processing, the prediction may be sent to a rules engine 320. The rules engine may have various components, includes a splitter 322, a strategy logic module 324, and a broker choice module 326. The rules engine 320 may form the core of the EO.

The prediction engine 314 may have an order performance calculator which may track order performance across various metrics and generate comparative performance statistics. The order performance calculator may process order and market data and generate absolute and comparative data points for each current live order. This information may be provided to the processing system 306. This data may be provided by electronic messaging.

The system 300 may be configured to allow traders to process orders with many models and using many different broker venues. New models may be moved in, existing models may be adjusted, and the models may be run simultaneously. Simulations may be run using the models. For example, the system may be run in a simulation mode instead of a production mode. The interface 312 may provide this scalability.

The rules engine 320 may apply a set of rules to the order. For example, the rules may further break up the order into smaller size chunks based on the investment bank's broker's rules. The rules may select a broker based on various factors. By way of non-limiting example, the broker may be selected based upon the type of order, commission, trading history, and volume of the order. For example, the rules may select a broker based on the order being for a large cap fund. The various components of the rules engine 320 may perform the logic of applying the various rules. The application of the rules may take into account the prediction from the model. Various data sources and modules may support the rules engine 320, including a broker module 328, a order type module 330, and a broker restriction module 332. These modules may be databases or may have databases associated therewith.

The broker module 328 may contain a listing of eligible brokers. The broker restriction module 332 may be work in concert with the broker module 328 to provide the necessary broker information for order execution. The data from the broker module 328 and the broker restriction module 332 may be loaded once a day, for example, upon system start-up in the morning.

The rules engine 320 may have a database holding historical order performance information. This database may include statistics. For example, the statistics may include the slippage, percentage of volume, and average price along with comparative numbers such as predicted performance versus actual performance, performance versus vwap, etc. This database may hold both historical information for a given period of time and current day information on orders that have been completed or canceled.

The rules engine 320 may interpret prediction information and other information. The rules engine module may provide: a determination of order split using the splitter 322, a selection of a strategy using the strategy logic module 324, and selection of a broker using the broker choice module 326. The rules engine may be able to process all incoming order flow and determine whether it should be handled manually or in an automated fashion. The rules engine may handle the trading for all automated order flow.

The splitter 322 may be included in the rules engine 320 or within the system 300 according to exemplary embodiments. The splitter 322 may make a determination regarding which trader or trading strategy should handle the order, the trading strategies which make decisions regarding order placement and handle order management, the broker eligibility process which identifies which brokers are available to send orders to, and the portfolio manager fit selector, which may select the correct fit to apply to an order upon order generation. The purpose of the splitter 322 may be to provide a process through which orders/blocks can be diverted either to traders or to the automated system. It may check each incoming order/block against its underlying attributes and the pre-defined parameters and may then either send the order back to the trader or assign it to the appropriate trading strategy. The splitter 322 may have the follow requirements:
Reading in new orders coming into the system.
Loading a table of restricted securities.
Loading a table of security Average Daily Volumes (“ADVs”) for a certain time period, for example, twenty (20) day ADVs.
Checking to see if the order is in the list of restricted symbols or if the order is greater than X percent of ADV.
Allowing the ADV percentage threshold to be a configurable value that can be reloaded intraday.
Sending orders which meet or exceed the above criteria to traders. All other orders may be directed to the automated trading strategies.
Processing each order in no more than two (2) milliseconds.

The strategy logic module 324 may have a trading strategy framework to makes decision regarding how each order which is assigned to it should be handled and then generates the appropriate placements. Each trading strategy may have the ability to listen to its own set of inputs and may have multiple internal logic sets which correspond to different modes of action within the overall strategy. Additionally, each strategy may maintain awareness of open placements, open cancels, and filled shares for each block it is executing. The trading strategy framework may have the following requirements:
Support multiple trading strategies, each with its own list of assigned orders.
Support an underlying set of modules with functionality that may be reused by each trading strategy. This set should include:
   Model Control
   Market Data Processing
   Prediction Data Processing
   Management of broker order placement and cancellation

Further, each trading strategy may:
Consist of multiple sub strategies.
Process new orders that have been assigned to the strategy.
Aggregate block information across all orders in the block within the strategy.
Read market data (best bid, best ask, best bid size, and best ask size) from the market data stream and reconsider decision logic on each update.
Read prediction data (block ID, price, size, strategy) from the prediction stream and reconsider decision logic on each update.
Make placement and cancel decisions at times triggered by the events listed below. The results of these decisions should placements and cancels which are generated and submitted to a stream for processing by the FIX engine.
Internally track the status of placements and cancels submitted.
Process each event and related decision calculations within a set period of time, for example, two (2) milliseconds.
Listen to fills generated from placements made by the strategy and reconsider its decision logic with each update.

The broker choice module 326 may manage a broker eligibility process using broker priority lists, may assist in the mapping of brokers to their available order types, and may manage filtering for broker exclusions. The data from the broker module 328 and the broker restriction module 332 may be used as part of this process. The broker eligibility process may sit as part of the library for the trading strategies, which may call into it when making placement decisions. The broker eligibility process may:
Read in a list or table of brokers and weightings/rankings.
Read in a list or table of available order types for each broker.
Read in a list or table of broker exclusions.
Support being called from a trading strategy, which may supply security ID and trading category.
Return to the trading strategy a list of broker and order type pairs for the eligible brokers, given the attributes submitted to it by the trading strategy.
Handle this processing in no more than a set period of time, for example, five hundred (500) microseconds.

The rules engine 320 may process various events. Various parts of the rules engine 320 may process different events. In some embodiments, the rules engine 320 may process each event with a single section. The rules engine 320 may use other systems or modules to provide the processing for certain events. While the actions herein may be described in a particular sequence, it should be appreciated that the actions may be performed in any order. Further, certain actions or sequences may be omitted.

When a new block or first order enters, it may be directed to the splitter 322. The splitter 322 may first retrieve and apply additional attributes to the block which are not already contained in the block message. Next, the splitter 322 retrieves and iterates over its filtering parameters, leading to a determination of which trader or trading strategy is appropriate. The splitter 322 may submit the order to the correct system. If the order is going into the automated system, the splitter may send a new trading strategy assignment message which may be read by the trading strategy and written to the trading strategy assignment table. The appropriate trading strategy may receives the assignment message and retrieve the relevant market data and prediction information. The trading strategy then may iterate through its decision logic. If it chooses to generate placements, it calls the broker table to retrieve the correct broker. The trading strategy may send the placement message to the appropriate stream and may store the placement in its open placements data structure.

The portfolio manager fit selector may receive the new block information, retrieves any necessary factors, and then may select the appropriate fit from the portfolio manager fits table. It may then publish this fit to the current fits table with the fit information and the associated block ID.

When a new order, not first in block, enters, it may also go to the splitter 322. The splitter 322 may check the trading strategy assignment table for the order's associated block. It may then transmit the order to the appropriate trading strategy or trader. The trading strategy may process the new order and recalculate total values for the block. It may retrieve a new prediction. It may then iterate through its decision logic and determine whether any cancellations or new placements are required and may proceed with any actions necessary.

The portfolio manager fit selector may recalculate the attributes of the block. It may then reselect the appropriate fit for the block and may update the current fits table with the new selection.

As shown by a placements module 334, the order may passed to an interface 340 for execution on the market after being processed by the rules engine 320. The order may be passed to a broker as determined by the rules engine 320. The order may be passed with appropriate instructions for execution based on the applied rules above. The broker may then trade the order on the market. The order may be passed to the broker via direct paths for market trading. For example, the order may be forwarded to the broker by way of a direct market access (“DMA”) pipe execution management system (“EMS”). It should be appreciated that many direct access pipes are provided by third party vendors. For example, the Lava Execution Management System is a direct market access product provided by a third party. Fill information may be received at a fills module 336 based on the placement from the brokers. The trading system may publish this data back to the prediction engine through the processing system 306 through various paths as shown.

As shown in the system 300, both the placements module 334 and the fills module 336 may provide information back to both the trading system 302 and the prediction engine 314. This information may be communicated through the use of the interface 304 and the interface 312. For example, fill information may be forwarded to the prediction engine 314 by the arrow 360 from the interface 312.

As shown by the path 342, some orders may be kicked out to an interface 344 with a Trader Execution Management System (“EMS”) 346. These may be orders that require further manual execution by a trader.

Feedback may received from the market 340 through a market data source 348. The market data source 348 may be a third party who collects, organizes, and analyzes market data to support investment banking function. For example, a market data feed from Reuters may be used. Market data may be received from the source 348 through an interface 350 and forwarded to a market data module 352. The feedback may be received in real time. This market data may serve as a form of feedback regarding the order execution. This feedback may be sent to the third party associated with the prediction engine 314. The feedback may be send through a control module 354 through an interface 356 to a prediction engine control module 358. The feedback may be used to update the prediction model and rules such that processing of the order may be adjusted in real time based on this market feedback. The rules engine can therefore apply iterative processing of the order. For example, based on feedback from the trading of the first block of share of the order, the trading parameters may be adjusted in real time. Brokers may be contacted to pull back orders or to cancel orders based on the revised information. The brokers may provide feedback on order fills.

Market data updates may be defined as a change in the best bid, best ask, best bid size, or best ask size. The trading strategy may choose to ignore some of these events (most typically the best bid/ask size changes). If it is an actionable event, the trading strategy may retrieve the current prediction, consider all blocks, examine open placements in the symbol with the change, and may make any cancellation or placement actions required.

Prediction updates may occur any time a new prediction is published for a block. Upon publication, the trading strategy may re-evaluate the block related to the prediction, examine any open placements for that block, and make any placement or cancellation adjustments required.

The control module 354 may be interface with the prediction engine control 358. The rules engine 320 may use the control module 354 in order to facilitate real time control and adjustment of the various pieces of the rules engine and to facilitate corrective action when there may be a system issue. The control module 354 and/or the prediction engine 358 may:
Listen to the model control stream
Filter for only those messages pertaining to the specific process in which it is currently functioning.
Enable/disable/adjust the functionality of the process for which it is listening to model control.
Verify that the action has been taken correctly.
Submit back to the model control stream a verification of the request action.

Further, according to exemplary embodiments, the order may be cancelled, amended, or removed from automatic execution at any point in the process, up to the actual execution of the order. If such an action is performed on an order, the order may be sent through the kick-out 342 to the trader EMS 346.

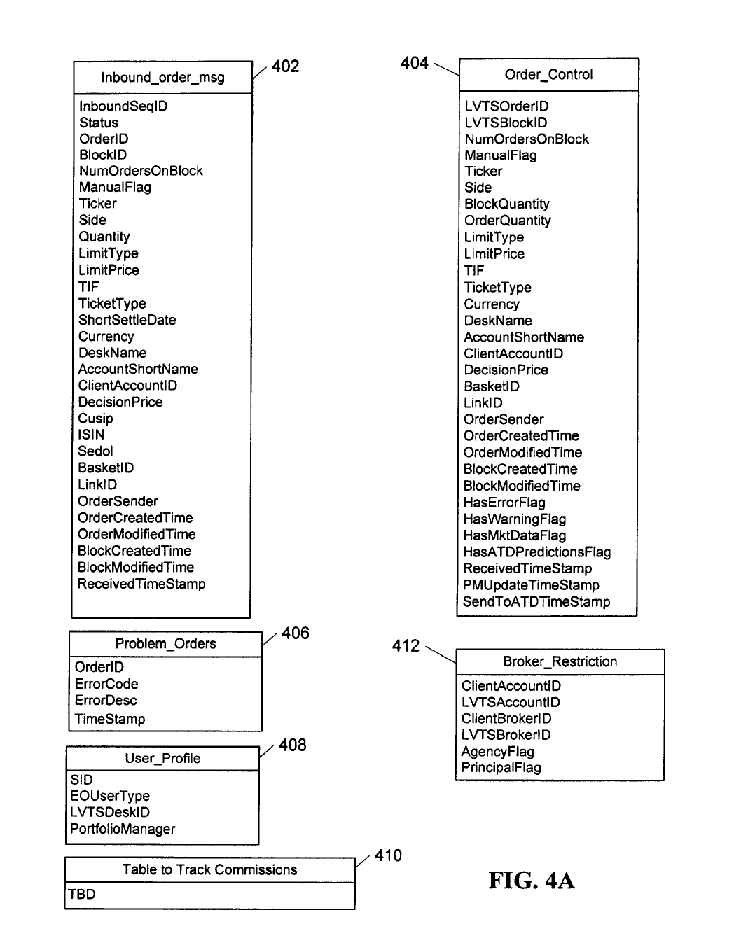

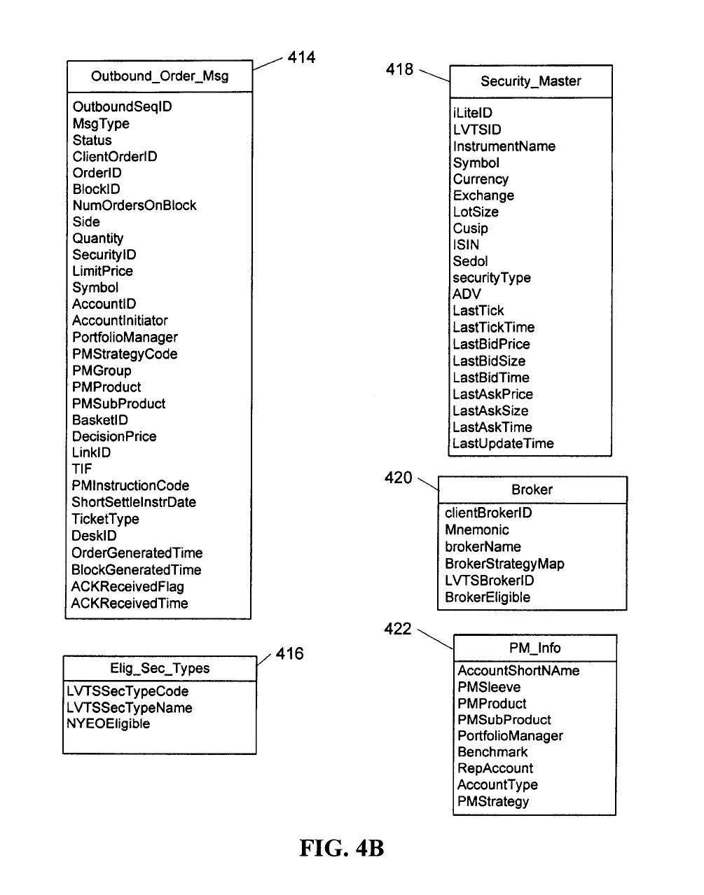

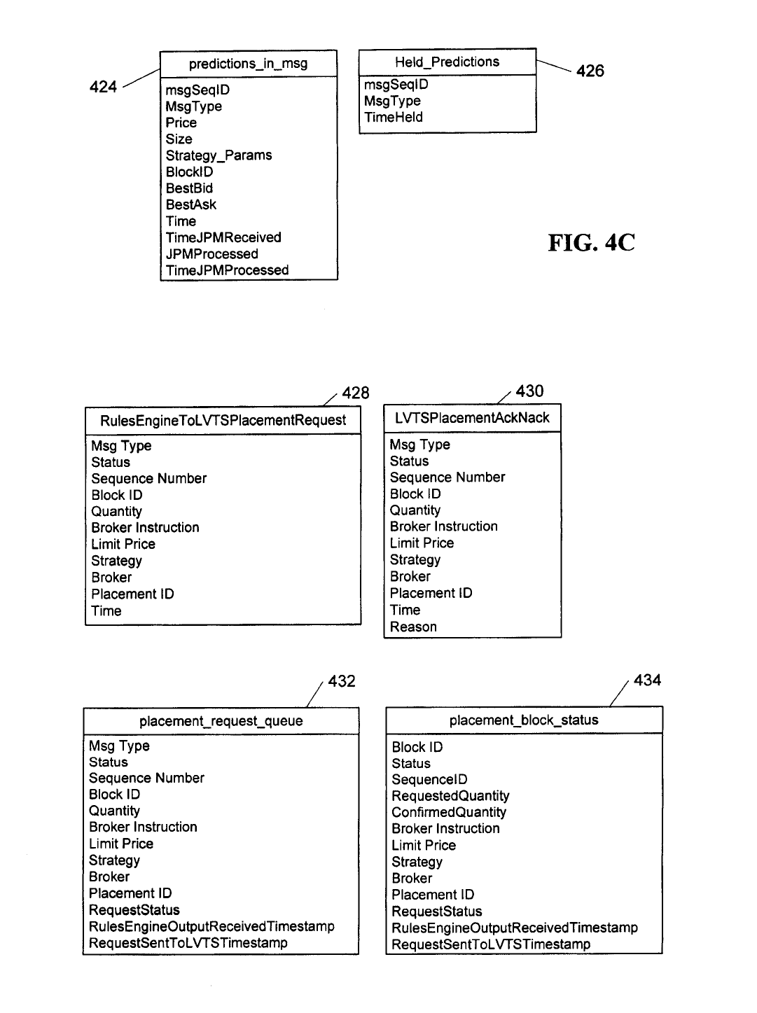

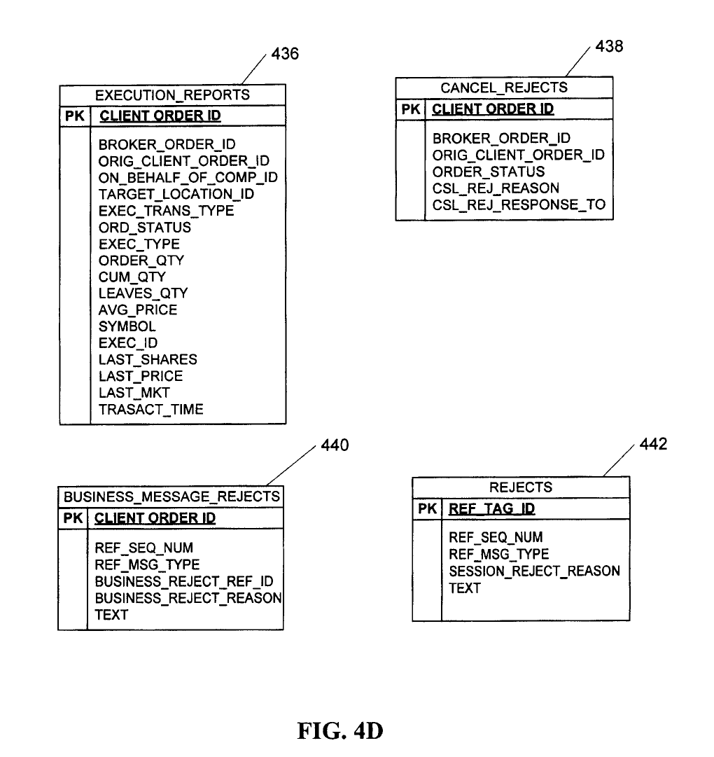

FIG. 4, as shown in FIGS. 4A-D, provides a listing of data associated with messages routed as part of the various stages of order processing as described herein. These data fields are provided by way of non-limiting example and it should be appreciated that additional data fields may be used. Further, a sub-set of these data fields may be used with certain orders; that is, some orders may not use all of the data fields. Additional data fields may be added to orders as required. The system may have reserved data fields for this additional data. Further, the system may have free form data fields in which personnel associated with the order may enter additional data as required. It should be appreciated that various combinations of the data fields may be used and new data fields may be added. The data fields may be appended with descriptive information to indicate the system or portion of the system that the data is associated with. For example, Inbound_order_msg may be appended with the prefix LVTS to become LVTS_Inbound_order_msg indicating that the field is associated with the LVTS. The various data fields are listed under a header name, this header name may used as a initial field label in a data stream and the various data fields may follow the header. The header name may serve as a partition to assist in parsing the data associated with the order.

Blocks 402, 404, 406, 408, 410, 412, 414, 416, 418, 420, and 422 are data fields used in relation to order flow. Blocks 424 and 426 are data fields associated with predictions from the prediction engine, for example, the prediction engine 314. Blocks 428, 430, 432, and 434 are data fields associated with order placements, for example the placements module 334. Finally, blocks 436, 438, 440, and 442 are data fields associated with order fills, for example the fills module 336.

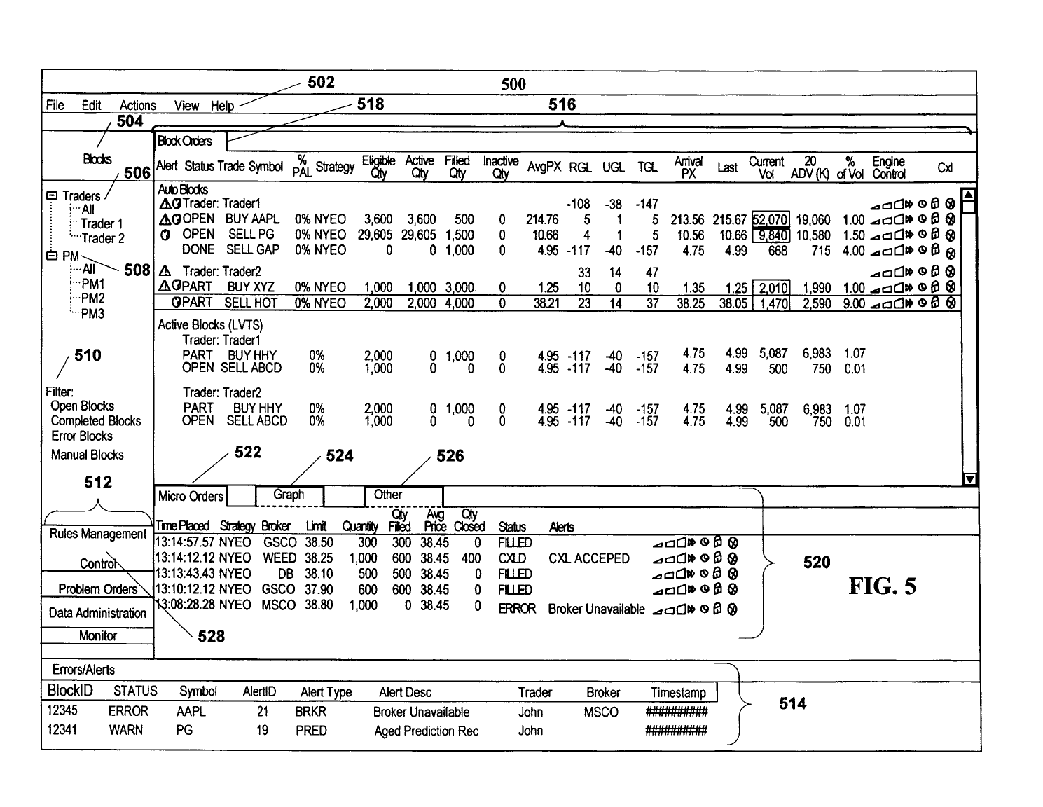

FIGS. 5 through 8 show embodiments of graphical user interfaces (“GUIs”) in accordance with exemplary embodiments. These GUIs are shown by way of non-limiting examples. The GUIs may provide a user interface for the systems described herein, such as the EO. Additional systems may be accessed from the GUIs shown. The GUIs may be accessed through a computer, for example, the workstation 210 as shown in the system 200 of FIG. 2. As shown in FIG. 2, the workstation 210 may be coupled to a network 235. The GUI may include the following:
a tool to view and manage order flow. A trader may be able to monitor how orders are being executed, with whom, and the end-to-end throughput;
a tool to place an order into or take an order out of the automated processing and control the level of aggressiveness on a particular order;
a tool to create and maintain rules;
a tool to maintain processing data; and
a tool to maintain and monitor a financial information exchange (“FIX”) engine.

Referring to FIG. 5, the elements of a GUI 500 are shown. While illustrative blocks, windows, menus, or components are shown, these illustrative blocks, windows, menus, or components may be arranged differently or modified in presentation. A menu selection bar 502 provides drop down menus to perform various actions and functions associated with the system. On the left hand side of the GUI 500, the blocks menu item 504 may provide a tree-like menu structure to provide access to order data associated the various traders (via heading 506) and portfolio managers (“PMs”) (via heading 508) that are associated with or active in the system. Each of the headings 506 and 508 may be expandable to provide greater fidelity and control over the data selection. For example, the headings 506 and 508 may be expanded as shown. A filter area 510 provides information on available filters for the data display. An appropriate filter may be selected be clicking on the desired filter's name. A selection area 512 provides button interfaces to select additional data views.

Turning to the bottom of the GUI 500, an error/alerts section 514 shows active errors and alerts with details for each item displayed.

On the right hand side of the GUI 500, a display section 516 displays data associated with the selected menu item from the left hand side. A tab 518 provides an indication of what is displayed. For example, as shown, the data corresponding to the blocks menu item 504 and the selected display items from the headers 506 and 508.

A lower section 520 provides a display area for additional data. The tabs 522, 524, and 526 provide for selection of various data displays. When one of the tabs 522, 524, or 526 is selected, that display may be pulled to the forefront and shown in the display area 520. For example, as shown, the tab 522 may be selected showing a micro order status.

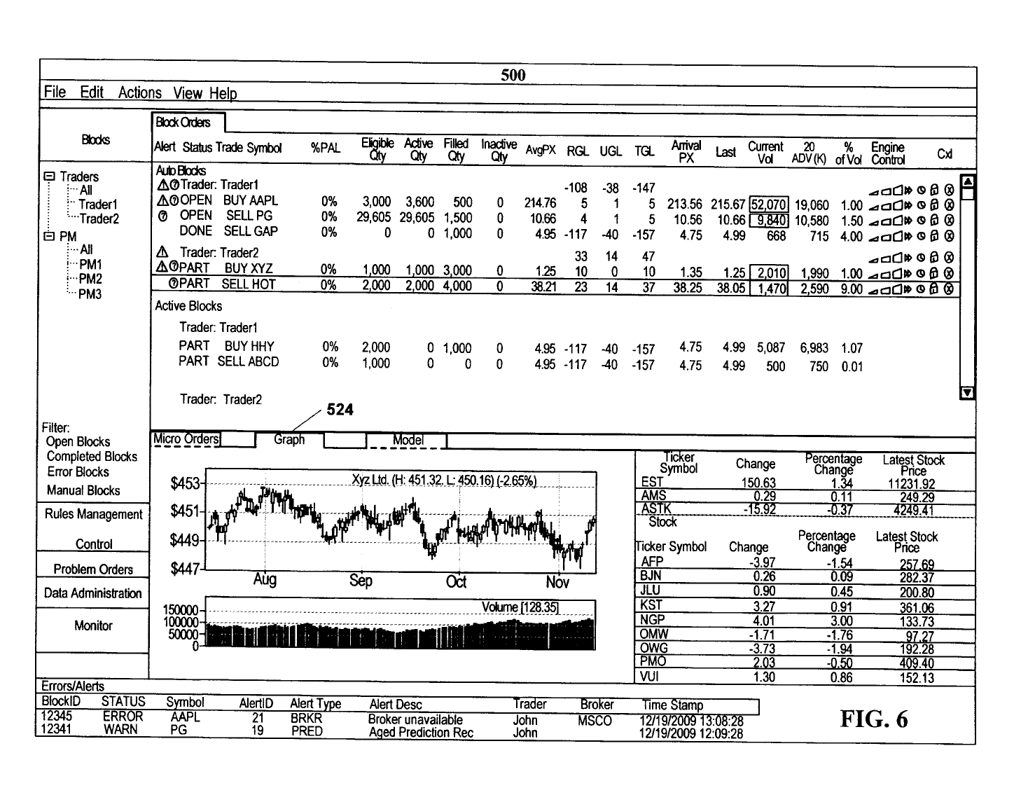

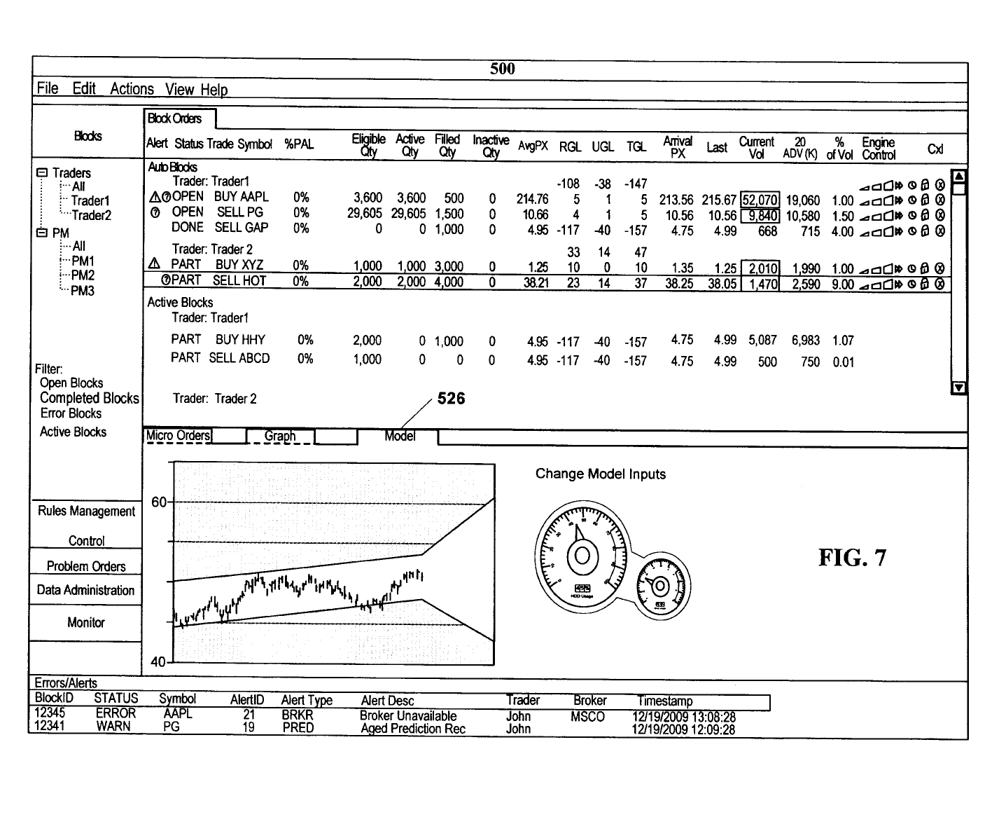

Turning to FIG. 6, the GUI 500 is shown with the tab 524 selected. The data displayed in the lower section 520 has been altered as shown. FIG. 7 shows the GUI 500 with the tab 526 selected.

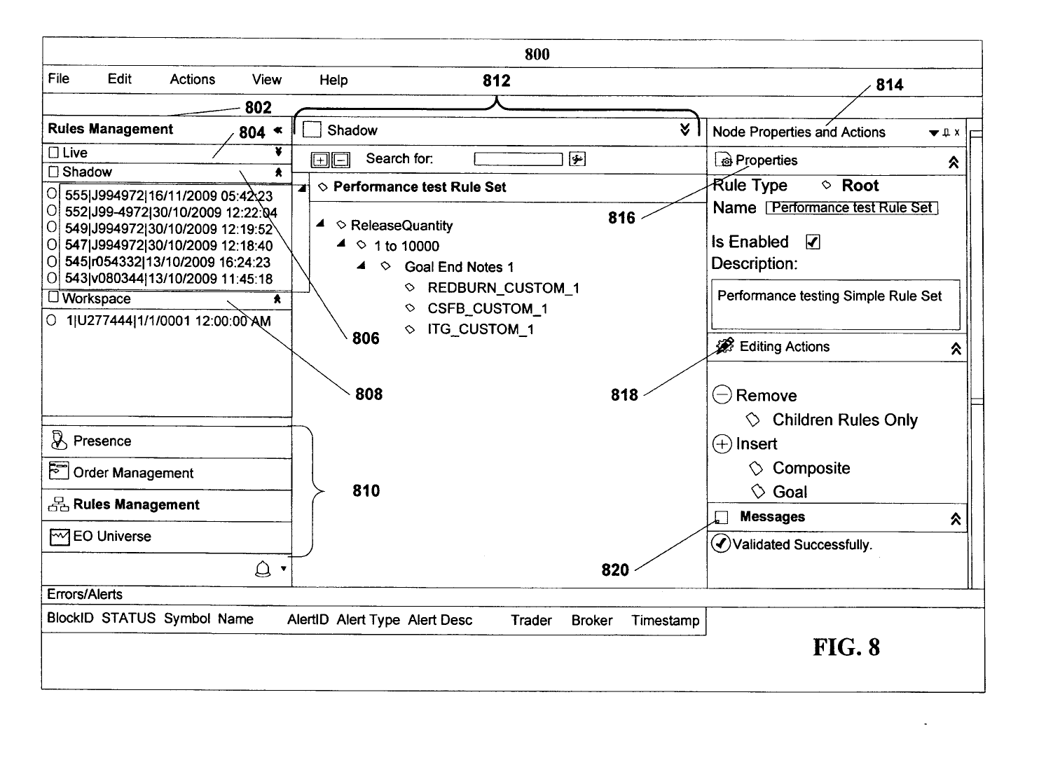

FIG. 8 depicts a GUI 800 showing a rules management tool 802. The rules management tool 802 may serve as an interface to the rules engine. Through the rules management tool 802, rules may be created, edited, and deleted. Access to the rules management tool 802 may be restricted. Under the rules management tool 802, are a number of menu options for rule selection. The live rule menu 804 provides access to live rules. The shadow rule menu 806 provides access to shadow rules. The workspace menu 808 provides access to rules in progress. Below those menus, a menu set 810 provides access to additional functions. In the center of the GUI 800, a work area 812 provides a tree-like hierarchy view of a selected rule. On the right hand side of the GUI 800, a node properties and actions menu 814 provides information and action selection for the selected rule. For example, a properties section 816 provides data about the selected rule, a editing actions section 818 allows for various editing actions to be performed, and a messages section 802 provides information about the rule.

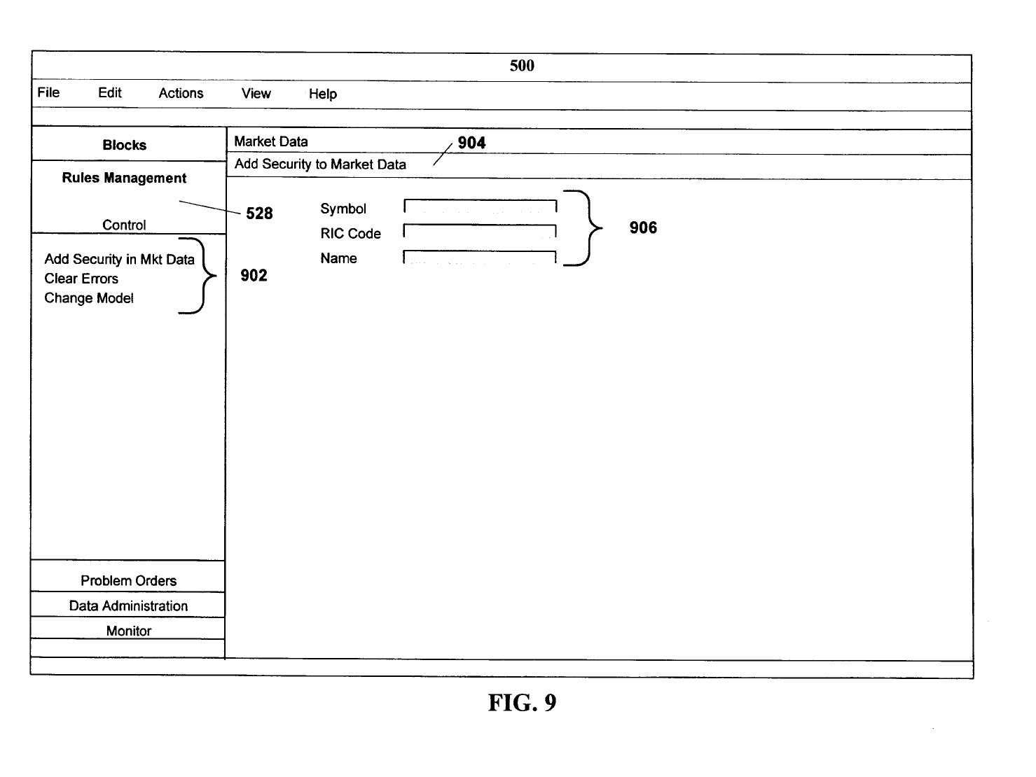

FIG. 9 shows the GUI 500 with the rules management control menu 528 selected from the menu area 512. As shown, menu items 902 are available on the left hand side of the GUI 500. Selection of a menu item 902 may result in a different display in the area 904. For example, as shown, the add security in market data is selected and a corresponding entry screen in shown in the area 904.

An embodiment of the present invention is directed to a Trader Workstation that includes a user interface accessible by various users over a network communication link. The user interface of an embodiment of the present invention provides complex customized visualizations of fast moving real-time data and historical time series. Further, the user interface provides flexible windowing specifics, including running multiple independent windows, tear offs, and alerting, for example. The Trader Workstation increases trading efficiency and availability of data for traders by enabling traders to better monitor, analyze and plan trades. An embodiment of the present invention may rely on the Execution Optimizer, described above in connection with FIGS. 1-9, to identify orders that may need attention.

An embodiment of the present invention enables traders and/or other users to monitor, analyze and plan orders. For example, using configurable views, filters and visualizations, traders may track and monitor orders in real time. An embodiment of the present invention may provide a trade analysis interface and a trade planning interface.

The trade analysis interface provides in-depth insights into active trade performance and projects the outcome for an order. The trade analysis interface may include real-time insights into trade performance including slippage, participation rate and profit and loss (P+L). The trade analysis interface may also provide custom alert configurations for order thresholds. Detail analysis of market performance including liquidity and pricing profiles may be provided. Also, order projection (e.g., slippage and participation rate) for a selected strategy may be available. In addition, mid-order what-if prediction and analysis on alternative order strategies as well as access to historical order movement and activity may be provided.

The trade planning interface provides insights when planning order execution to ensure a strategy is optimized to maximize opportunity. The trade planning interface may include historical trade profile analytics for portfolio managers, sectors and/or similar sized trades. Detailed analysis of market performance including liquidity and pricing profiles may be provided. Also, the trade planning screen may include generation and visualization of trade schedules, including expected participation rate and profit and loss. Custom alert configuration may be provided for order thresholds.

An embodiment of the present invention may include a desktop application that is accessible by traders and/or other users. For example, traders associated with a particular financial institution may access the system, as well as multiple trader groups from a plurality of financial institutions and/or other entities. Desktop capabilities may include control over window management and alerting/notification capabilities. Also, browser-based options may be provided.

An embodiment of the present invention may access various services, including a Symbology service, a Market Data service, an Alert service, a Reference Data service, an Order Management service, a Profile service, a Blotter service and a Trade Planner service. Additional services may also be provided. The services, described in detail below, may be combined and/or separated across one or more modules or processors.

The Symbology service may act as a security master for a Trader Workstation application. Among other responsibilities, it may provide mappings between different symbols as may be required or preferred by upstream services APIs and instrument metadata (e.g., sector, industry, etc.). Indicative exemplary requirements for the service APIs may include: get a list of relevant symbology, including unique ID assigned by a financial institution or other source and a set of relevant symbols, e.g., ticker, RIC, BBG, SEDOL, CUSIP/ISIN, etc.; get instrument metadata, including sector, industry, and others as may be required or desired; and provide the information for tradable instruments and indexes. Other functions and features related to symbology services may be provided.

The Market Data service may provide instrument level prices and volumes, which may be aggregated per configured time interval (e.g., bin, etc.). The data may be sourced from various sources for historical data and real-time prices and volumes. Indicative exemplary capabilities for asynchronous service APIs may include: get stock price (e.g., time series); get stock volume (e.g., time series) and get index price (e.g., time series). Other functions and features related to market data may be provided.

The Alert service may provide the following exemplary functionality: subscription for alerts, where alerts settings may be indicated per a user's profile; subscription to relevant services; and generation of alerts and pushing them to the client. Other functions and features related to alerts may be provided.

The Reference Data service may provide various lists (e.g., static for the duration of the session, etc.) which may be required or preferred by application, for example, for allowing selection, filtering, grouping, etc. This service may provide the following indicative exemplary capabilities: get list of desks; get list of traders; get list of portfolio managers; and get list of sectors. Other functions and features related to reference data may be provided.

The Order Management service may interface with upstream systems and other venues. Unless routing is specified, the service may embed a routing logic to different venues. The service API may provide the following exemplary indicative capabilities: send order for execution; suspend order; cancel order; resume order; get order fills (e.g., snapshot and real/time updates: timestamp, price, quantity, etc.); and subscribe to pending orders stream (e.g., either full order details, or counts plus getting snapshot, etc). Other functions and features related to order management may be provided.

The Profile service may use a persistent store to save the profile between sessions. Other storage mechanisms and devices may be used. Exemplary features may include: save/retrieve user preferences; save/restore windows layout; save/retrieve alerts settings (e.g., thresholds, etc.); and save/retrieve the watch list. Other functions and features related to profile services may be provided.

The Blotter Service may stream order execution data to the client. The service may aggregate the basket level data from the underlying orders and stream aggregated data to the clients. Relevant data may be sourced from several of upstream systems. Exemplary features may include: get list of active orders (e.g., snapshot); subscribe for active order updates; snapshot and updates for basket orders; snapshot and updates for a given list of orders (e.g., watch list). Other functions and features related to blotter services may be provided.

The Trade Planner service may provide various analytics and predictive information about the market and the order. The information may come from various systems. Exemplary features may include: get expected market volume (e.g., time series, etc.); get projected remaining liquidity for the day (e.g., time series, etc.); get instrument trade profile (e.g., 1D, 2D, 1W, 1M, etc.) for a stock, historical and for three execution scenarios; get scheduled percent filled pre-trade (e.g., time series, computed); get scheduled percent filled for executing order (e.g., time series, saved, etc.); get target (e.g., expected, etc.) price pre-trade; get expected slippage (e.g., given current state and aggression level, etc.) and get predicted participation rate. Other functions and features related to trade planning may be provided.

FIG. 10 is an exemplary screen shot of a home screen in accordance with exemplary embodiments. A user may view data in a table view at 1030 and a visualization view at 1060. The exemplary home screen provides persistent filtered views that drive data represented in an exemplary table and other visualizations, as shown at 1010. Additional tabs provide other visualizations, such as Large Cap—All 1012, Large Cap/Small Cap 1014, and a particular trader 1016. The ability to add additional filtered views may be provided at 1018. For example, a user may create a new view by defining a view name and filtering conditions including desk (e.g., all, small cap, large cap, quant, etc.), trader (e.g., all, particular trader name, etc.) and sector (e.g., all, communications, consumer, energy, financial, industrial, technology, etc.). By saving the setting, a new tab may appear, at 1018.

Tab 1020 represents exemplary filters and controls for visualization and tabular format. In this example, data may be grouped by category, shown by 1020, order size shown by 1022 and percentage complete shown by 1024. Group by Category 1020 allows the user to group objects in the table view and visualization view by a type including Portfolio Manager and Sector. Order Size 1022 may use a two sided low/high slider that ranges from the smallest to biggest order on screen. Percentage Complete 1024 may use a two sided low/high slider that ranges from 0% to 100%. Other filters and variations thereof may be applied.

Table view 1030 is an exemplary tabular representation of block orders within the view that is selected. Pending 1040 represents a new order indicator and access point. Watch List 1050 provides an access and input point for watch list data.

Visualization view 1060 provides a visual representation of block orders within the view that is selected. 1052 indicates the x axis and 1054 indicates the y axis that the visualization view 1060 is currently using to plot objects. The user may also select the measure that is mapped to metrics. Exemplary metrics may include Slippage (Price Weighted Participation); Slippage (Implementation Shortfall); Slippage (Cost Estimate); Participation Rate; Percentage of Available Liquidity; and Percentage difference from plan. Other metrics may be applied.

As shown in Visualization view 1060, Order 1062 represents a basket of orders, where a basket name and a number of orders within the basket may be displayed. Order 1064 represents a non order flow router (OFR) block order, where a name of the order, side and size may be shown. Order 1066 represents an order flow router (OFR) block order, where a name of the order, side and size may be shown. In this example, non OFR block orders are shown with solid lines while OFR block orders are shown with dashed lines. Other indicators and graphics may be used. Bubble sizes represent the size of the order relative to each other. The user may also interact with the orders by zooming in and out on regions of the chart to see more detailed view.

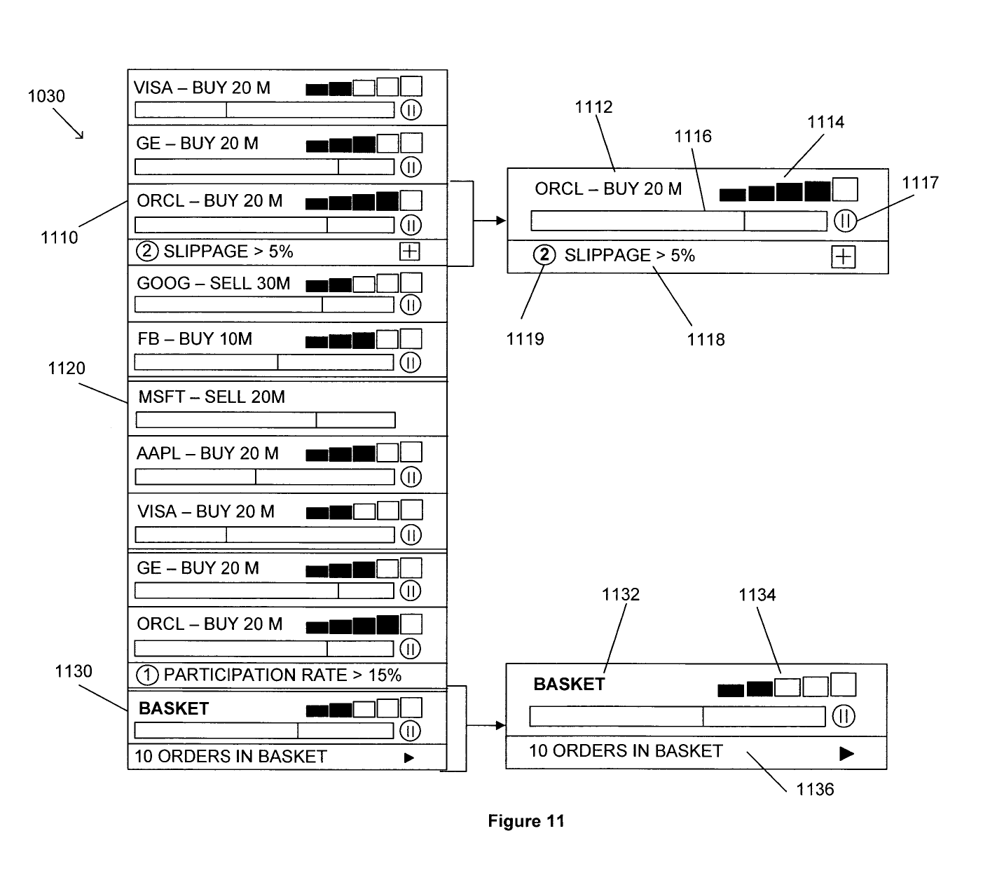

FIG. 11 is a detailed view of block orders in accordance with exemplary embodiments. Table view 1030 of FIG. 10 illustrates OFR Block Orders, Non-OFR Block Orders and Basket.

Block Order 1110 represents an exemplary OFR block order where a user may alter execution activities. For example, a user may alter the aggression as well as resume and pause the order. The user may also access more detailed performance and execution information about the selected order by interacting with the block order. For example, the user may click or double click to view varying degrees of information. Other user interactions may be implemented.

An expanded view of Block Order 1110 may illustrate the name, size and side for the order, shown by 1112. Graphic 1114 indicates a current level of aggression for an order and allows the user to change the level by clicking other aggression levels: Bar 1116 indicates a level of completeness for an order and 1117 allows the user to pause and resume orders. Also, on mouse over (or other interaction), a percentage complete may be shown, e.g., 55%. If a threshold alert or signal has been triggered for an order, this may be indicated at 1118. If there is more than one alert as indicated at 1119, the most recent may be displayed, and the remaining may be seen by expanding the view. Other variations on the user interaction and details displayed may be provided.

Block Order 1120 represents an exemplary non-OFR block order. A user may view information about this order, but may be restricted from interacting with its execution.

Basket 1130 represents a basket of block orders. In this example, a user may alter the orders. Also, varying degrees of restrictions may be applied. For example, a user may alter execution activities, which may include modifying the aggression, resuming and pausing for some or all orders within it. Basket 1132 may indicate the name of the basket or other identifier. Graphic 1134 may indicate a current level of aggression for the basket and further allows the user to change the level by clicking other aggression levels. 1136 indicates the number of orders in a basket. The user may click to expand and view some or all of the block orders within the basket. Other variations on the user interaction and details displayed may be realized.

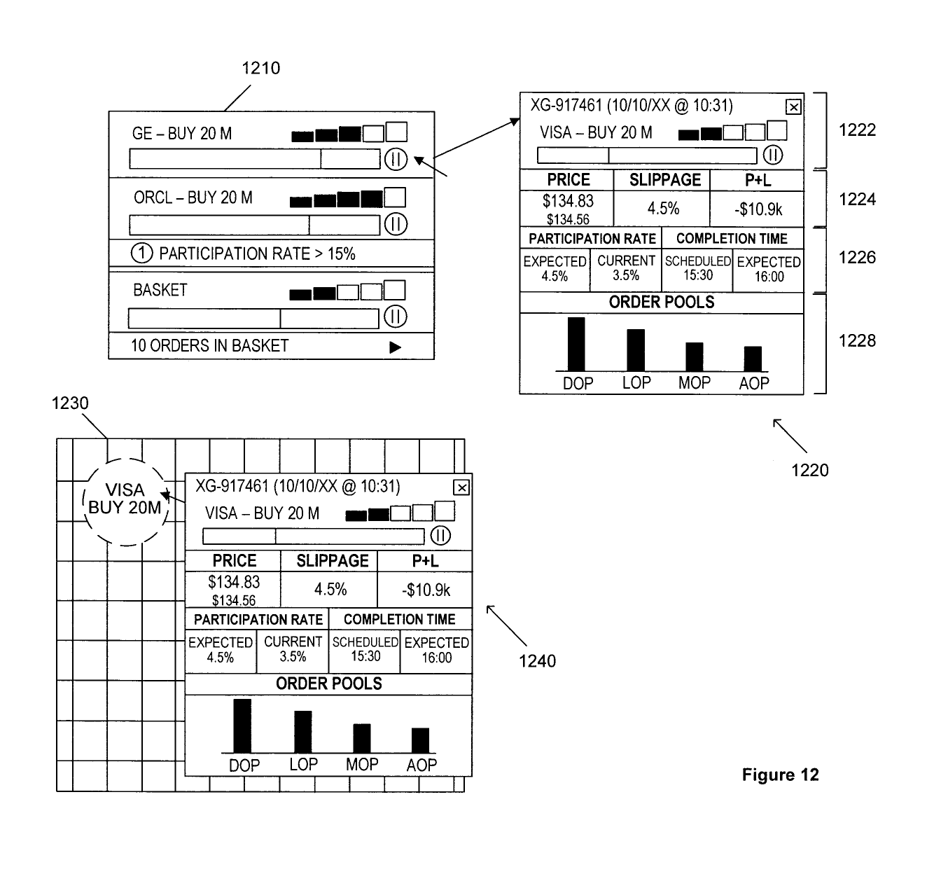

FIG. 12 illustrates exemplary block order interactions in accordance with exemplary embodiments. FIG. 12 illustrates exemplary user interactions (e.g., single click) with a table view and a visualization view. When a user clicks (e.g., single) on a block order within the table view as shown by 1210, a floating order overview widget 1220 for the selected order may be displayed. Widget 1220 may include detailed order overview information. At Section 1222, order ID and arrival time may be shown. Also, at 1222, name, size and side for the order may be displayed. A current level of aggression for an order may be displayed, where the user may change the level by clicking other aggression levels. A level of completeness for an order may be shown. The user may also pause and resume orders.

Section 1224 may indicate the most recent price, expected price, current slippage as well as profit and loss. Section 1226 may indicate an expected and a current slippage for the order as well as scheduled and expected completion time. Display 1228 provides a breakdown of order pools that have been traded for the order. Other details and variations may be provided.

In a similar manner, when a user clicks (e.g., single click) on a block order within the visualization view 1230, a floating order overview widget 1240 for the selected order may be displayed.

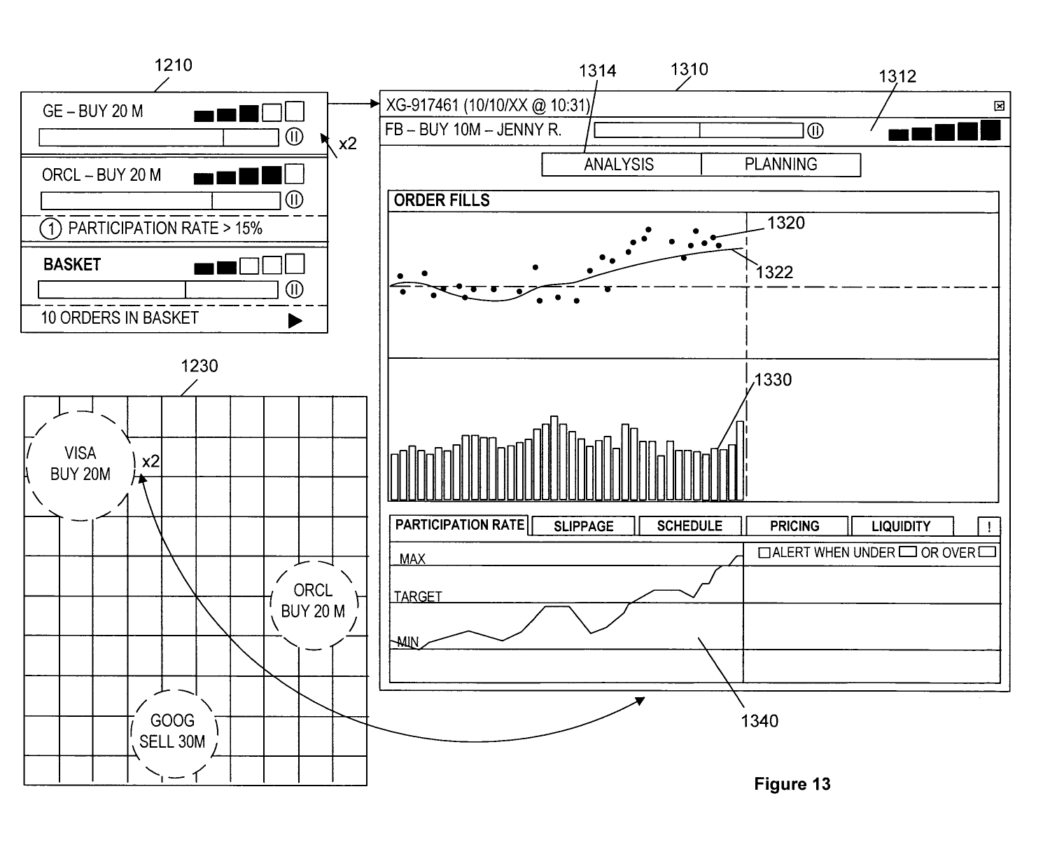

FIG. 13 illustrates exemplary block order interactions in accordance with exemplary embodiments. FIG. 13 illustrates exemplary user interactions (e.g., double click) with a table view and a visualization view. When a user clicks (e.g., double) on a block order within the table view as shown by 1210, an order details screen 1310 may be displayed. Likewise, when a user clicks (e.g., double) on a visualization view 1230, an order details screen 1310 may be displayed. Order active trade details screen 1310 may include details concerning order fills.

Section 1312 indicates name, size and side for the order, a current level of aggression for the order and a level of completeness for the order. As noted above, the user may change the level of aggression by clicking other aggression levels and also pause/resume orders. As shown here, the analysis tab 1314 is activated. Tab 1314 also enables a user to toggle between the analysis and planning screens for the selected order. Point 1320 indicates a successful placement (e.g., fill) for the order at the price it was filled. Line 1322 indicates a midpoint price for the selected name, where the name may refer to a stock identifier that is being traded. Real time charts show information about the order's fills overlaid on market data from order start to finish. Bar 1330 indicates a volume traded price for the selected name. Chart 1340 shows additional information about the order in the same or similar time series as the Order Fills chart(s) above. Also, the user is able to tab between different charts (e.g., Participation Rate, Slippage, Schedule, Pricing, Liquidity, etc.) to see different data and information.

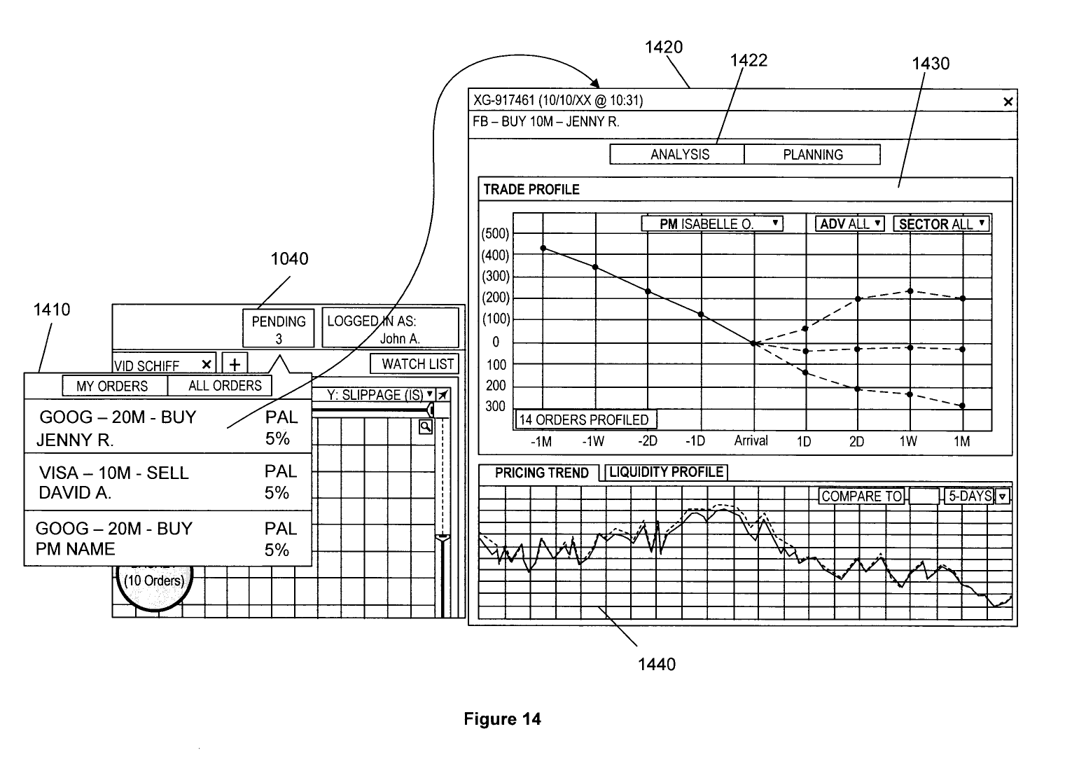

FIG. 14 illustrates an exemplary pending orders feature in accordance with exemplary embodiments. When a new order for planning arrives, it may be added to a pending orders queue. The pending orders queue may be accessed by clicking on the pending order indicator 1040. When an order is added to the pending order queue, the pending order indicator may flash briefly to indicate a new order is pending. Other graphics, animations or indicators may be used. After a use clicks the pending order indicator (or otherwise interacts with the interface), a list of some or all of the orders that are pending may appear. The user may toggle between their own orders, some orders and all pending orders. For each order, the following details may be shown at 1410, including name of the order, size of the order, side of the order, Portfolio Manager of the order, and the percentage of average (PAL) liquidity for the order.

Following a user selecting an order from the list, a trade planning screen 1420 may be displayed. Screen 1420 illustrates an analysis view at 1422, where the user may toggle between the analysis and planning screens for the selected order. Based on the name's price activity (e.g., reversal, momentum or neutral), manager profiles may be plotted for a plurality of scenarios that show expected movement in price based on prior trade history, at chart 1430. In this example, three scenarios are shown. A scenario may be plotted for the manager's profile when they are out of the money, in the money and at the money. Other scenarios may be applied. When a user hovers (or via other interactions) on a scenario, it may gain focus and show a standard deviation around it. The trade profile may be automatically filtered by the PM. The user may then filter further by average daily volume, sector and/or other criteria.

Chart 1440 shows a historical pricing trend for the name over the period of time specified. Here, the user may enter an index to chart on the same axis as a comparison. By selecting Liquidity Profile, a corresponding chart may be shown that illustrates an expected volume for the day against an actual traded for the day. For example, the expected volume profile may be based on the average volume traded over the previous period selected (e.g., 5 days).

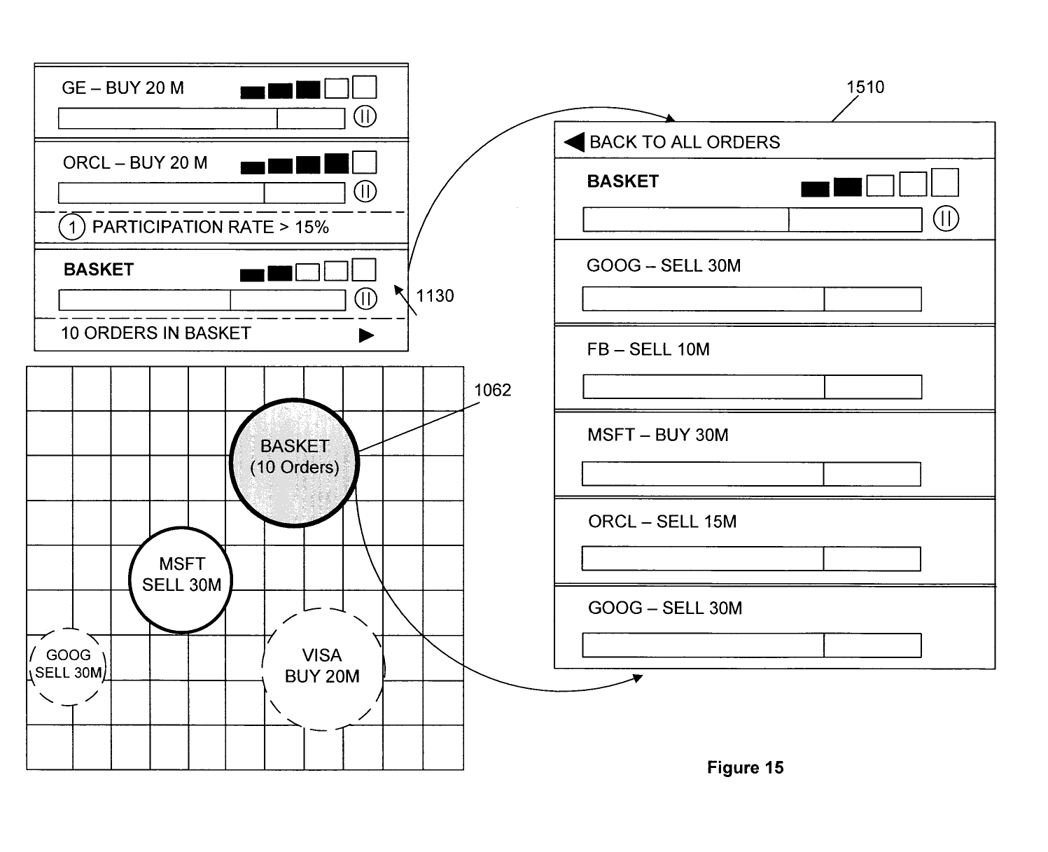

FIG. 15 illustrates exemplary basket interactions in accordance with exemplary embodiments. A user may interact with the basket view in various ways. In this exemplary illustration, a user may double click on the basket in the table view 1130. In this example, double clicking on basket order in the table view 1130 or the visualization view 1062 opens the basket up to reveal some or all of the order within it, as shown by 1510. Certain restrictions may be applied. For example, orders within the basket may not be intervened. The table view 1130 may update to show a breakdown of some or all the orders within it. The visualization view 1062 also updates to show the orders within the basket (some or all other orders that are not in that basket may disappear).

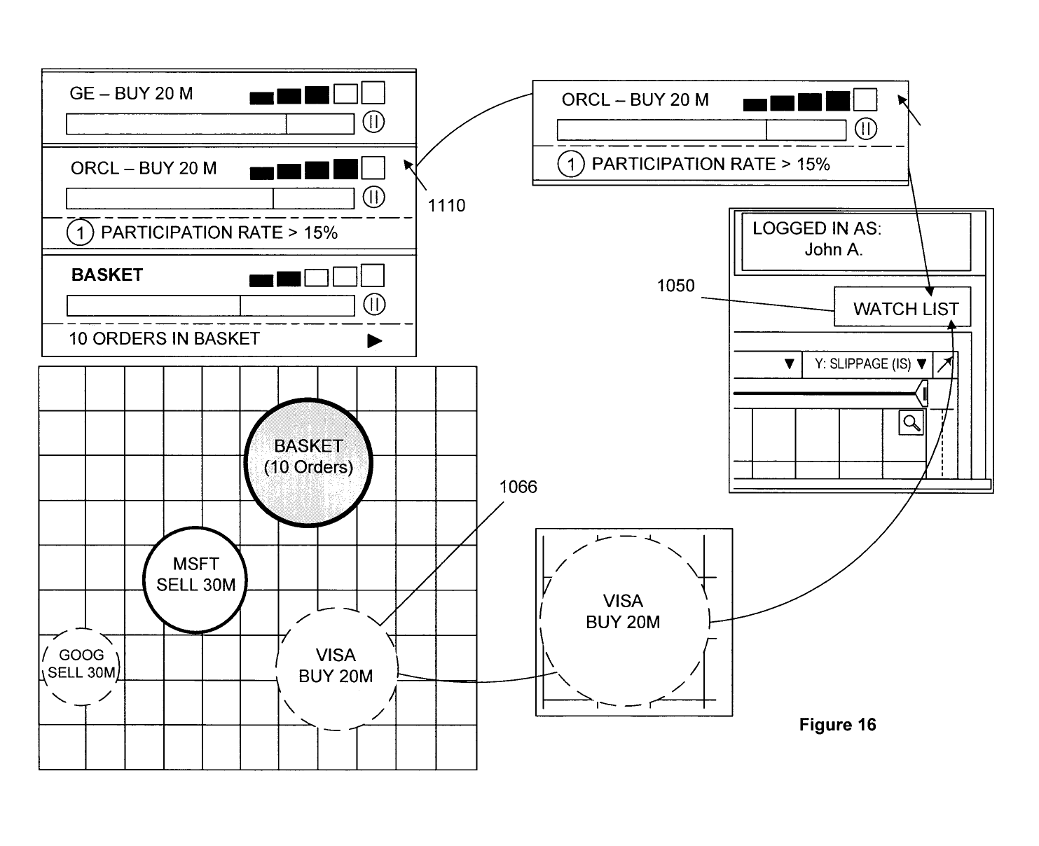

FIG. 16 illustrates an exemplary watch list in accordance with exemplary embodiments. Block orders may be added to the watch list by dragging and dropping them into the watch list region on the home screen. Other user interactions may be implemented. For example, a user may select a block order 1110 and drag the block order to the watch list 1050. The block order may be selected from the table view, as shown by 1110 or from the visualization view, as shown by 1066. Each time an order is added to the watch list 1050, it may immediately show up in the watch list window. The watch list region 1050 may also confirm that the order has been added by briefly highlighting, changing colors, or displaying other graphic or animation.

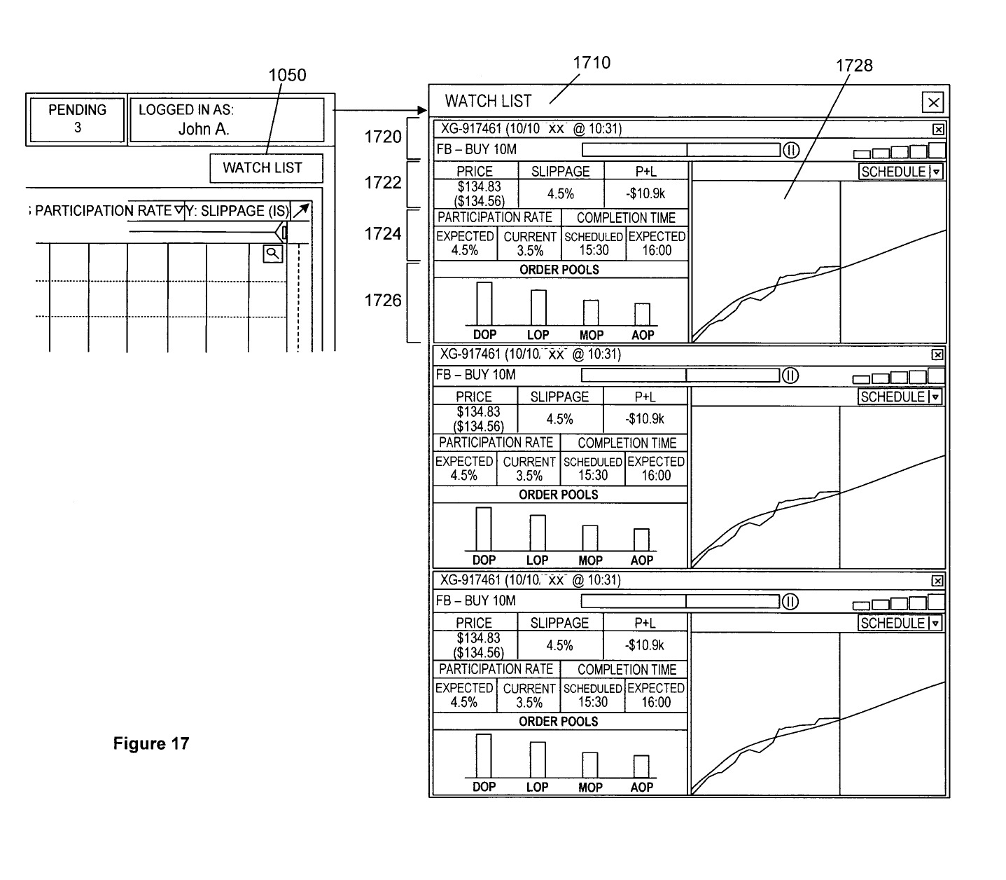

FIG. 17 illustrates a detail view of an exemplary watch list in accordance with exemplary embodiments. The watch list may be accessed by clicking on the Watch List button 1050 from the home screen of FIG. 10. By clicking on Watch List 1050, a detailed view may be displayed at Watch List screen 1710. For each order that is added to the watch list, the following information and functionality may be available: overview and order controls (for relevant orders); high level metrics (as per order overview); a widget that allows user to toggle between different charts and functions including: Participation Rate, Slippage, Schedule, Pricing, Liquidity and Alerts (as per order analysis). Each of these widgets may be updated in real-time. When an order is complete, the order may remain on the screen until the user chooses to remove it.

At Section 1720, order ID and arrival time may be shown. Also, name, size and side for the order may be displayed. A current level of aggression for an order may be displayed, where the user may change the level by clicking other aggression levels. A level of completeness for an order may be shown. The user may also pause and resume orders. Section 1722 may indicate the most recent price, expected price, current slippage as well as profit and loss. Section 1724 may indicate an expected and a current slippage for the order as well as scheduled and expected completion time. Display 1726 provides a breakdown of order pools that have been traded for the order. Chart 1728 provides a graphical illustration of various metrics, including Participation Rate, Slippage, Schedule, Pricing, Liquidity and Alerts (as per order analysis). Other details and variations may be provided.

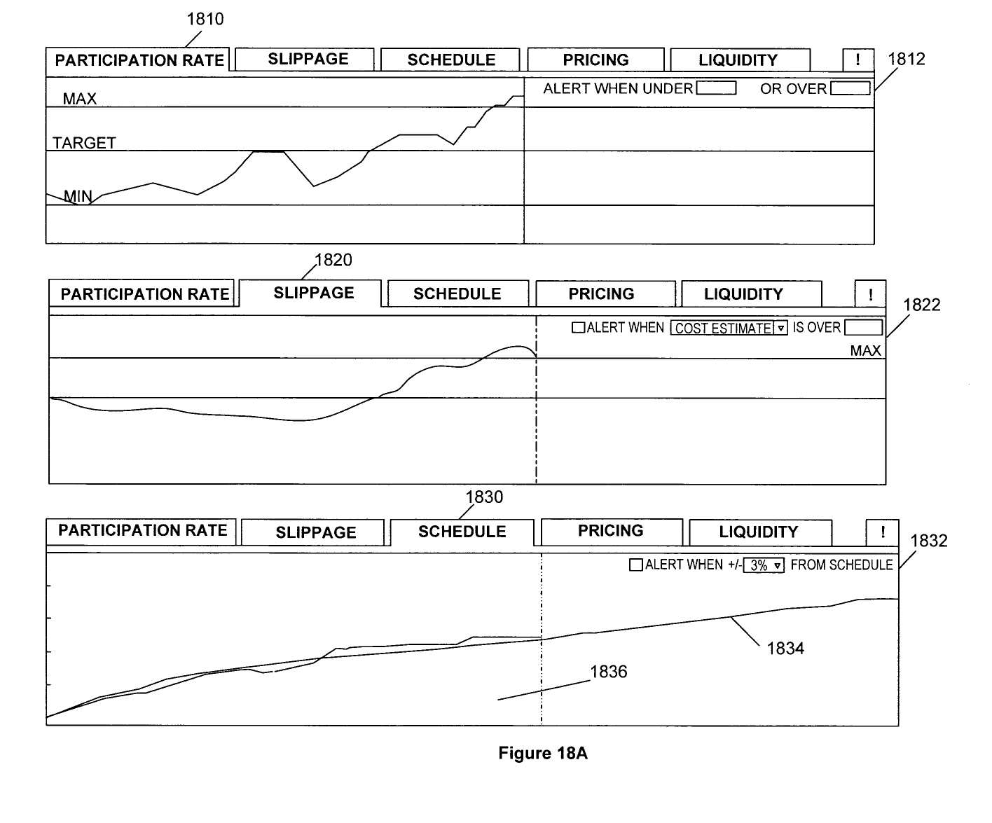

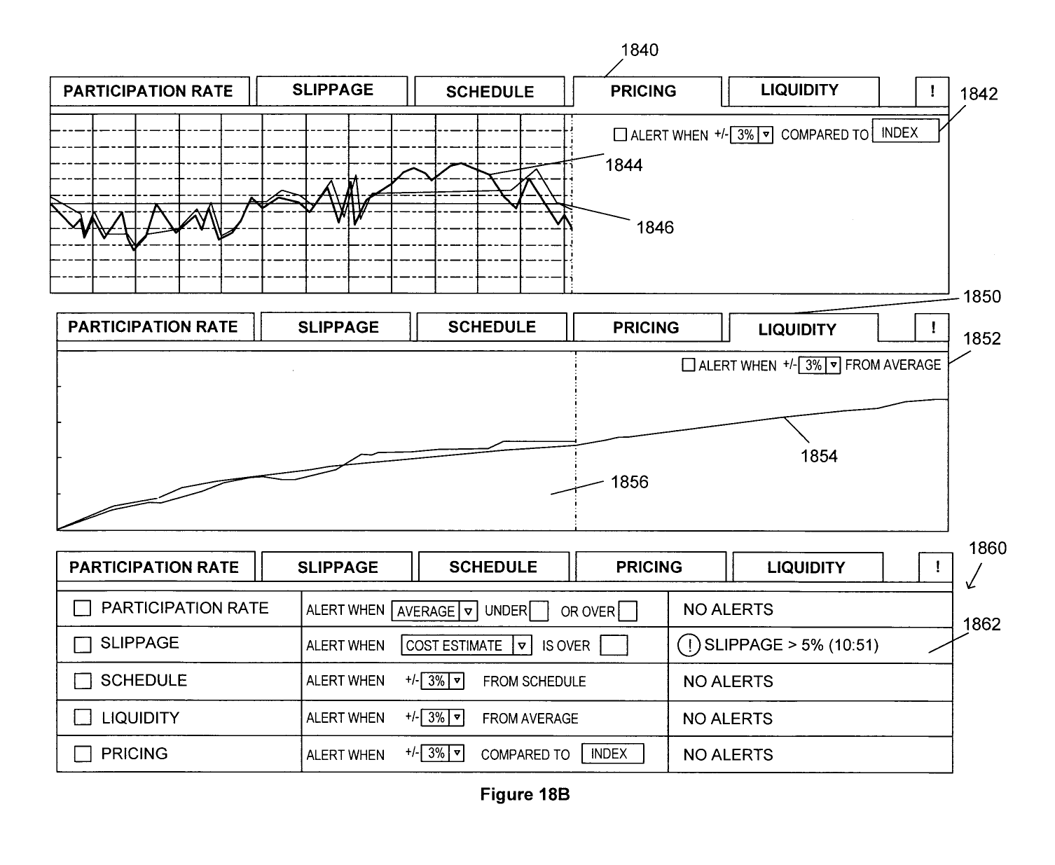

FIGS. 18A and 18B are exemplary order active trade details screenshots in accordance with exemplary embodiments. Graph 1810 indicates a participation rate for the block order in real time. If available, a target participation line may be plotted. Also, a minimum and maximum participation rate levels may be plotted to indicate alert level thresholds. At 1812, a user may set/toggle alerts for participation rate (e.g., high/low levels, etc.). For example, the user may indicate a low level or high level for implementing an alert.

Graph 1820 indicates a slippage (for slippage metric selected) for the block order in real time. Also, a maximum slippage may be plotted to indicate alert level thresholds. At 1822, a user may set/toggle alerts for slippage (e.g., high threshold, etc.).

Graph 1830 indicates a planned schedule and may show an actual order activity that has occurred. At 1832, a user may set/toggle alerts for schedule deviation. 1834 may indicate the planned schedule. 1836 may indicates a realized execution rate.

As shown in FIG. 18B, graph 1840 indicates a market price for the name of the block order in real time. An index may also be plotted in real time. At 1842, a user may set/toggle alerts for deviation to a selected index. Plot 1844 indicates a price for the name and plot 1846 indicates a price for the index.

Graph 1850 indicates an expected volume traded (e.g., 20 day average volume profile) against the real time cumulative volume traded. At 1852, a user may set/toggle alerts for a percentage or other amount above or below an average. Plot 1854 indicates to an expected volume for the day (e.g., based on 20 day average). Plot 1856 indicates an actual traded volume for the day.

Chart 1860 illustrates a summary of available/active alerts for a block order. Alerts may be toggled on and off. For each alert that is toggled on, variables may be entered to define when they are triggered. 1862 indicates any alerts that have occurred and the time they occurred. The alert itself may also be customized. For example, the user may specify the type of alert (e.g., email, text, voicemail, phone number, etc.) along with other customized preferences.

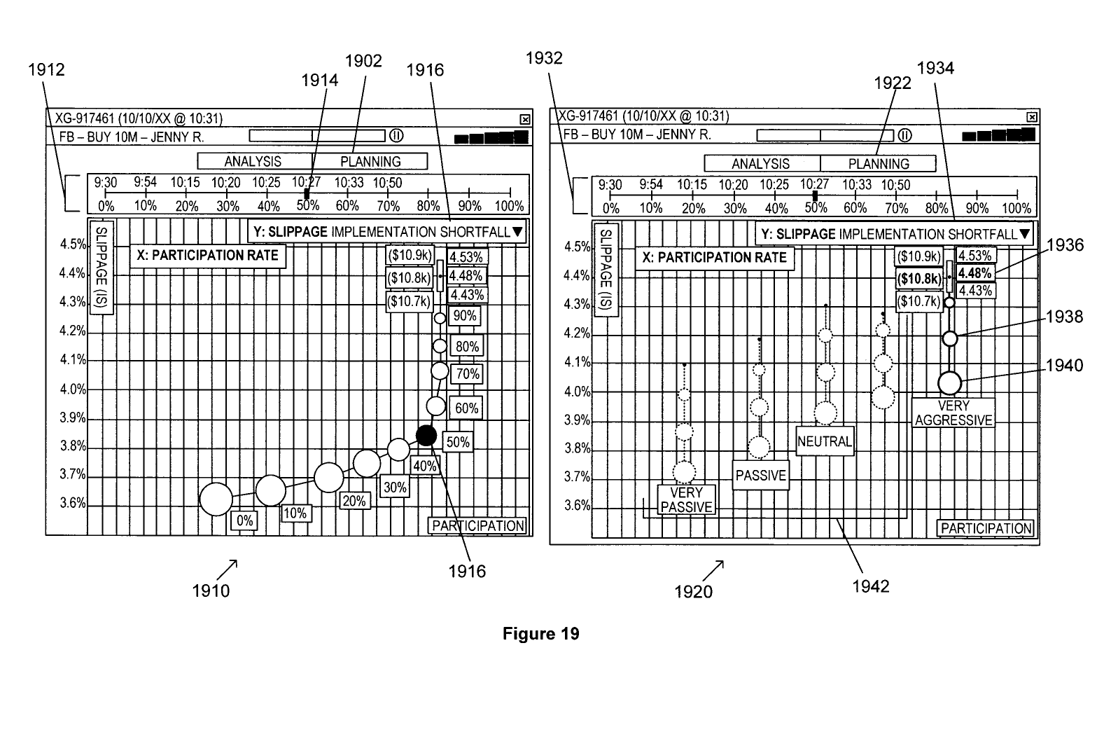

FIG. 19 is an exemplary illustration of a planning screen for order details in accordance with exemplary embodiments. Chart 1910 and Chart 1920 indicate a planning view, as shown by 1902 and 1922, respectively. Time sliders 1912 and 1932 allows a user to interact with chart 1910 and chart 1920, respectively, to view an order's behavior change over time. The slider may be broken into increments, such as 10% increments (based on order completion), and may further indicate the time that each point occurred. For example, when the user is interacting with slider 1912, chart 1910 may focus on the selected path 1916 and highlight the selected tick 1914.

Chart 1910 and Chart 1920 may include an indication of the axis that order paths are plotted on, at 1916 and 1934, respectively. Here, the x axis represents a participation rate and the y axis represents a slippage implementation shortfall in both Chart 1910 and Chart 1920. The user may select the slippage metric used for display. As shown in Chart 1920, 1936 indicates a projected slippage and profit and loss for the selected strategy in addition to one standard deviation for both figures. 1938 shows steps to completion for remaining volume (e.g., 70% complete would show 3 additional steps to completion, 50% would show 5 additional steps to completion, etc.). 1940 indicates the order's current position. 1942 indicates the possible paths for strategies that are not currently active/selected. When a user mouses (or performs other interaction) over one of these paths, it may become highlighted as per the active strategy. The bubble size shrinks as the bubble nears completion. Other graphics and indicators may be used.

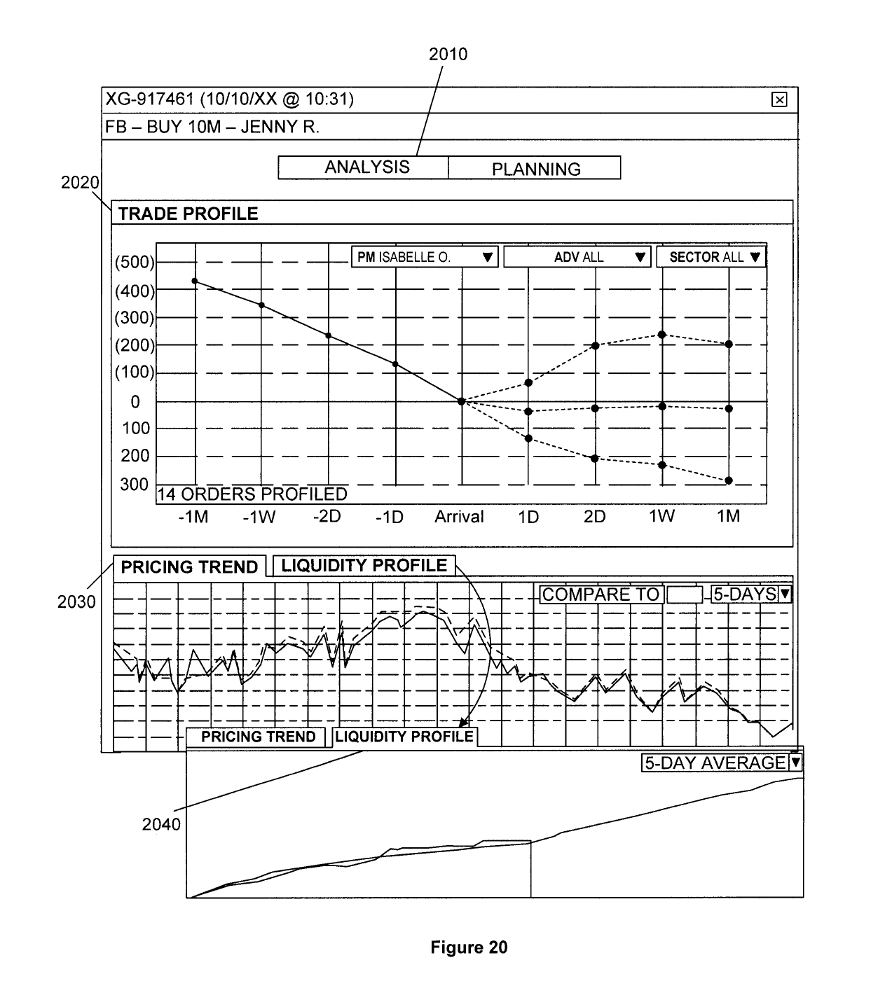

FIG. 20 is an exemplary screen shot illustrating analysis for a new order in accordance with exemplary embodiments. FIG. 20 illustrates an analysis view as shown at 2010, however, the user may toggle between the analysis and planning screens for the selected order. Based on the name's price activity (e.g., reversal, momentum or neutral), manager profiles may be plotted for a plurality of scenarios that show expected movement in price based on prior trade history, at Trade Profile 2020. In this illustration, three exemplary scenarios are shown by dashed lines. A scenario may be plotted for the manager's profile when they are out of the money, in the money and at the money. Other scenarios may be shown. When a user hovers on a scenario (or performs other interaction), it may gain focus and show a standard deviation around it. The trade profile may be automatically filtered by the PM. The user may then filter further by average daily volume and sector.

Chart 2030 shows a historical pricing trend for the name over the period of time specified. Here, the user may enter an index to chart on the same or similar axis as a comparison. By selecting Liquidity Profile, a corresponding chart 2040 may be shown that illustrates an expected volume for the day against an actual traded for the day. In this example, the expected volume profile may be based on the average volume traded over the previous period selected (e.g., 5 days).

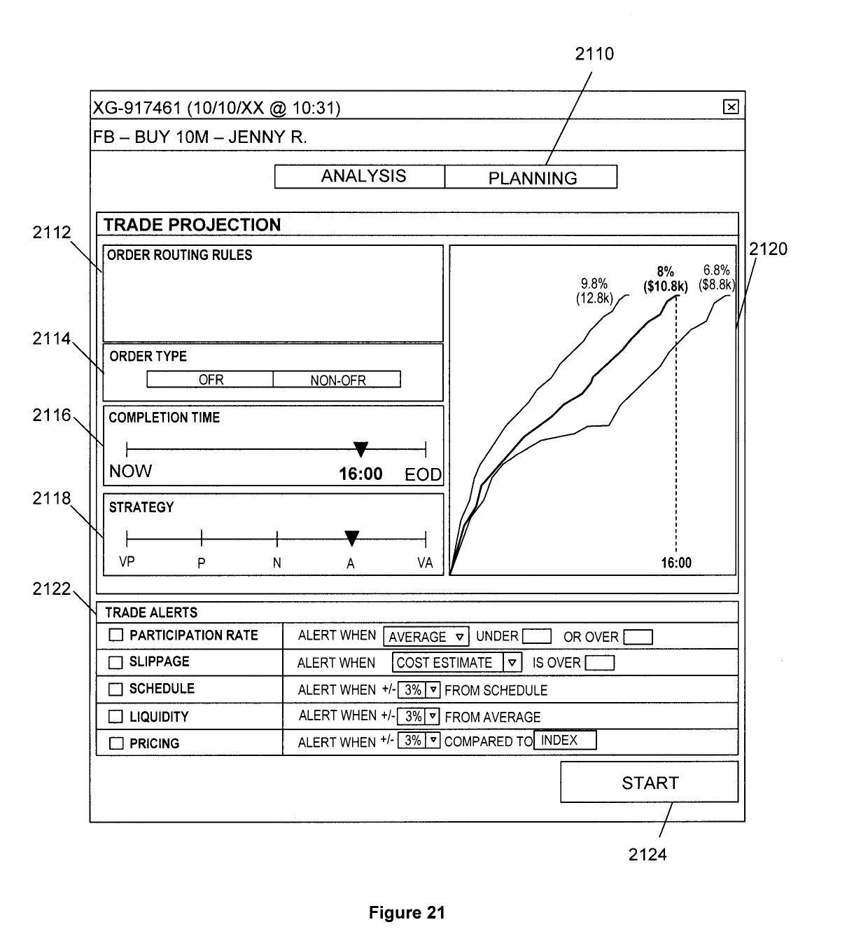

FIG. 21 is an exemplary screen shot illustrating a planning page or a new order page in accordance with exemplary embodiments. If applicable, any order/name routing rules or other information may be displayed for reference at 2112. At 2114, the user may select the order type. Here, the user may select from OFR or Non-OFR. Other options may be available. At 2116, the user may enter or indicate a planned completion time and at 2118, the user may enter or indicate a strategy for the order. Based on the planned completion time and strategy entered for the order, a projected schedule may be shown at 2120. In this exemplary illustration, an anticipated participation and indicative P+L may be shown at 2120. Lines for one standard deviation may also be plotted on the same chart (including participation rate and P+L) or on a corresponding chart or other graphic. Also, non-OFR projections may be modeled using an OFR strategy as a proxy. Users may select a strategy that the user believes to be comparable to the broker's algorithm or specific order options. Trade Alerts 2122 allows the user to activate alerts and set the variables that will trigger them for the alert they are working. Using the settings that have been entered above, the user may initiate an OFR order using the start button at 2124.

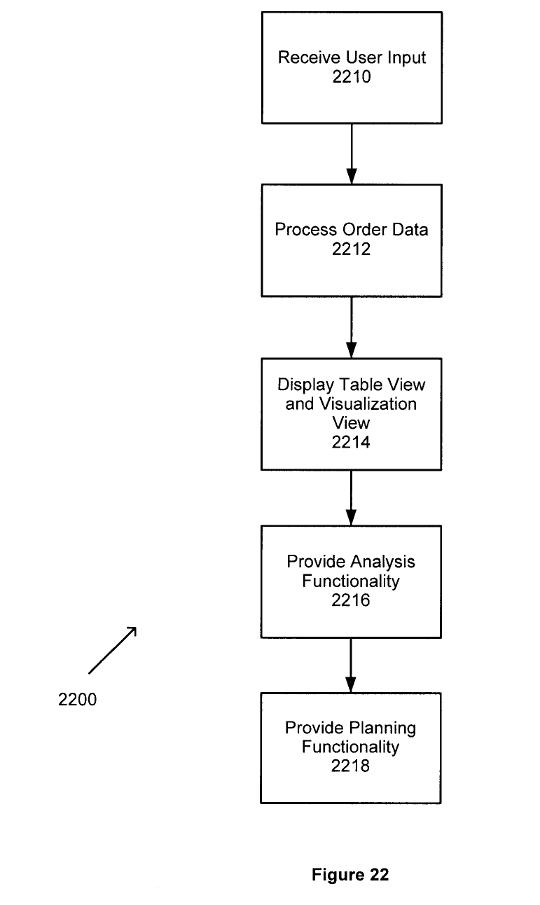

FIG. 22 is an exemplary flowchart of a method for optimizing the execution of an order in accordance with exemplary embodiments. Exemplary method 2200 is provided by way of example, as there are a variety of ways to carry out the methods disclosed herein. The method 2200 as shown in FIG. 22 may be executed or otherwise performed by one or a combination of various systems, such as a computer implemented system. Each block shown in FIG. 22 represents one or more processes, methods, and/or subroutines carried out in the exemplary method 2200. Each block may have an associated processing machine or the blocks depicted may be carried out through one processor machine. While the exemplary method 2200 may use an order from a client for stocks as an example of optimizing an order, the method shown in FIG. 22 may be applied to other types of orders, such as other securities or other types of financial transactions.

While the method of FIG. 22 illustrates certain steps performed in a particular order, it should be understood that the embodiments of the present invention may be practiced by adding one or more steps to the processes, omitting steps within the processes and/or altering the order in which one or more steps are performed.

The method of FIG. 22 may commence with receipt of a user input relating to an order for one or more specified securities, at step 2210. An order may be received by a workstation having an interactive interface, according to an embodiment of the present invention. At step 2212, an embodiment of the present invention may process order data associated with the order. At step 2214, the order data may be displayed on a table view and a visualization view. The user may apply configurable views, filters and other visualizations where users may track and monitors orders in real time. An exemplary illustration may include FIG. 10. At step 2216, analysis functionality may be provided. Analysis functionality may enable a user to view active trade performance and also project the outcome for an order. Exemplary analysis functionality may include real-time insight into trade performance; custom alert configurations for order thresholds; detailed analysis of market performance; order projection for strategies, prediction and analysis on alternative order strategies; and access to historical order movement and analysis. At step 2218, planning functionality may be provided. Planning functionality may enable a user to plan an order execution to ensure a strategy is optimized to maximize opportunity. Exemplary planning functionality may include historical trade profile analysis; detailed analysis of market performance; generation and visualization of trade schedules and custom alert configurations for order thresholds.

An embodiment of the present invention may provide notifications and alerts. For example, when a new pending order arrives, the user may receive a visual notification. Clicking on the alert may take the user to the trade planning screen for this order. As for alerts, the trader workstation may alert the user when a number of different types of scenarios/criteria are met. These may be threshold based alerts or information (signal) based alerts. Threshold Alerts may be alerts that are triggered against different measures for orders. These measures and thresholds are based on variables set by the user for one or more of the following: Participation Rate, Slippage, Schedule, Liquidity, and Pricing, for example. Also, signals may be alerts that are triggered by an incoming system message.

When an alert is triggered, a visual indicator may be shown for that order on the screen as in the following exemplary ways. Alerts on the table view may be indicated by color and a summary of the alert may be shown in various ways. For example, if there is more than one alert, the most recent may be displayed, and the remaining may be seen by expanding the accordion. Alerts on the visualization view may be indicated by color (or dash line, darker line) surrounding the bubble for the relevant order. Other graphics and variations may be applied.

The various embodiments of the present invention provide users with a great amount of flexibility and access to comprehensive views of complex and detailed information. This enables users to make more informed decisions and plan more effectively. For example, a user may manage various views by creating filtered views. Here, the user may create groups of orders as persistent views. Also, the user may display multiple views simultaneously.

By the various embodiments of the present invention, a user may also monitor block orders. For example, a user may track active blocks from the table view 1030, as shown in an exemplary screenshot of FIG. 10. The user may also track active blocks using the visualization also shown at 1060 of FIG. 10. A user may identify performance problems or issues. For example, a user may get rule based alerts and signals from the table, shown at FIG. 11, as well as from the visualization, shown at 1060 at FIG. 10, for example, shown by 1062, 1064 and 1066. A user may check execution health by accessing a summary of an order from the table view as well as from the visualization view, shown by FIG. 12.

A user may manage block orders, in accordance with an embodiment of the present invention. For example, a user may change an execution plan by pausing an order, resuming an order and editing an aggression of an order. An exemplary illustration may be shown by 1112 at FIG. 11.

Analysis and adjustment of orders may also be provided. For example, a user may check market and placement history. As shown in FIG. 13, a user may view market activity, placement history and order performance. Other information and varying levels of detail may also be shown. As illustrated in FIG. 19, Screen 1920 demonstrates order projections for selected and alternative strategies. Also shown in FIG. 19, Screen 1910 provides an instant replay of an order's behavior and performance.

An embodiment of the present invention enables a user to plan new trades. For example, a user may watch for new orders. A notification may be displayed as new orders arrive. Also, a user may view pending new orders as shown by 1410 in FIG. 14. A user may evaluate previous executions by evaluating manager/trade profiles for similar orders. An exemplary screenshot may be shown by 1420 at FIG. 14. Also, a user may select and tweak strategies. FIG. 21 illustrates an exemplary screen where a user may set, tweak and model an execution strategy for execution.

An embodiment of the present invention enables a user to manage a watch list. For example, a user may add orders to watch list from the table view and the visualization view, as illustrated by FIG. 16. Watch list orders may be displayed in detail, as shown by FIG. 17. By viewing details about each order in the watch list in real time, a user may effectively monitor the watch list orders.

Hereinafter, aspects of implementation of the exemplary embodiments will be described. As described above, the method of the invention may be computer implemented as a system. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. For example, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of media or medium, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the embodiments have been particularly shown and described within the framework of execution of trades, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, uses and advantages of the present invention will be apparent to those skilled in the art from consideration of the specification and practice of the invention disclosed herein. The specification and examples should be considered exemplary.

1. A computer based system for optimizing automatic execution of an order for securities, comprising:
one or more computer processors communicatively coupled to a network, configured to provide an interactive interface for user interaction with the computer based system, and the one or more computer processors are further configured to:
receive an order for specified securities;
apply a profile to the order, wherein the profile comprises data pertaining to one or more trading habits of a portfolio manager,
route the order and the profile to a prediction model;
receive results from the prediction model;
apply a set of rules to the order for determining an execution strategy for the order;
route the order for execution in accordance with the set of rules and the results from the prediction model;
receive a user input relating to the order via the interactive interface;
process order data associated with the order and further display the order data on a table view and a visualization view on the interactive interface, wherein the order data comprises at least one of: the order, the profile, the results from the prediction module, and the set of rules;
provide analysis functionality and display active trade performance data, based at least on a portion of the order data; and
provide planning functionality and display trade profile analytics, based at least on a portion of the order data.

2. The system of claim 1, wherein one or more user selected filters are capable of being applied to the order data displayed on the table view and the visualization view.

3. The system of claim 1, wherein the table view displays a current level of aggression for the order data that is modifiable by the user.

4. The system of claim 1, wherein the table view displays one or more orders and the user can pause and resume each order.

5. The system of claim 1, wherein the visualization view displays a representation of a plurality of orders respective to each other.

6. The system of claim 1, wherein the active trade performance data comprises real-time data associated with one or more of: slippage, participation rate and profit and loss.

7. The system of claim 1, wherein the active trade performance data comprises order projection data for a selected strategy.

8. The system of claim 1, wherein the trade profile analytics comprises historical trade profile analytics for one or more of: portfolio managers, sectors and trades.

9. The system of claim 1, wherein the trade profile analytics comprise market performance.

10. The system of claim 1, wherein the one or more computer processors are further configured to allow for a customization of one or more alerts based on one or more user defined conditions.

11. A computer based method for optimizing automatic execution of an order for securities, comprising:
receiving, by one or more computer processors, an order for specified securities;
applying, by the one or more computer processors, a profile to the order wherein the profile comprises data pertaining to one or more trading habits of a portfolio manager;
routing, by the one or more computer processors, the order and the profile to a prediction model;
receiving, by the one or more computer processors, results from the prediction model;
applying, by the one or more computer processors, a set of rules to the order for determining an execution strategy for the order;
routing, by the one or more computer processors, the order for execution in accordance with the set of rules and the results from the prediction model;
receiving, by the one or more computer processors, a user input relating to the order via an interactive interface;
processing, by the one or more computer processors, order data associated with the order and displaying the order data on a table view and a visualization view on the interactive interface, wherein the order data comprises at least one of: the order, the profile, the results from the prediction module, and the set of rules;
providing, by the one more computer processors, analysis functionality and displaying active trade performance data, based at least on a portion of the order data; and
providing, by the one more computer processors, planning functionality and displaying trade profile analytics, based at least on a portion of the order data.

12. The method of claim 11 further comprising, applying one or more user selected filters to the order data displayed on the table view and the visualization view.

13. The method of claim 11, wherein the table view displays a current level of aggression for the order data that is modifiable by the user.

14. The method of claim 11, wherein the table view displays one or more orders and the user can pause and resume each order.

15. The method of claim 11, wherein the visualization view displays a representation of a plurality of orders respective to each other.

16. The method of claim 11, wherein the active trade performance data comprises real-time data associated with one or more of: slippage, participation rate and profit and loss.

17. The method of claim 11, wherein the active trade performance data comprises order projection data for a selected strategy.

18. The method of claim 11, wherein the trade profile analytics comprises historical trade profile analytics for one or more of: portfolio managers, sectors and trades.

19. The method of claim 11, wherein the trade profile analytics comprise market performance.

20. The method of claim 11, further comprising: customizing one or more alerts based on one or more user defined conditions.
